(19) United States
(12) Patent Application Publication
(10) Pub. No.: US 2023/0086317 A1
(43) Pub. Date: Mar. 23, 2023

(54) Robotic muscle utilizing inchworm actuation

(71) Applicant: Alexander Sergeev, San Francisco, CA (US)

(72) Inventor: Alexander Sergeev, San Francisco, CA (US)

(21) Appl. No.: 17/880,582

(22) Filed: Aug. 3, 2022

Related U.S. Application Data
(63) Continuation-in-part of application No. 63/259,703, filed on Aug. 3, 2021.
Application No. 63/259,703 is a continuation-in-part of application No. 63/284,578, filed on Nov. 30, 2021.

(51) Int. Cl. B25J 9/10

(52) U.S. Cl. CPC B25J 9/1075

(57) ABSTRACT

An actuated or mobile device such as a mobile robot or robotic muscle is provided, wherein mobility may be enabled by means of novel models of inchworm actuator positioned to tighten, loosen, move, or pull on one or more strings or tendons to directly or indirectly effect motion. The clamp elements of the inchworm actuator may include the novel optimization of being H-shaped and/or including a ‘beak’ element. Inchworm actuators tightening and/or loosening strings or tendons may cause ‘foot’ elements to rotatably extend from or tuck into a surface of the device, enabling the device to pull itself along. The device may include one or more moveable joints implemented as a bow joint. One or a grouped set of inchworm actuators pulling tendons may be used to rotate an axle, particularly for implementing a robotic joint around the axle.

### FIELD OF THE INVENTION

This invention relates to inchworm actuator technology as utilized particularly in robotics, and more specifically to optimizations in clamp grip and design simplicity, and providing of novel locomotions and applications.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Generally speaking, anywhere there is powered movement by a machine, there's an actuator that translates power from an energy source into physical motion, such as a motor that spins a shaft (a rotary actuator) or one that pushes or pulls on whatever may be attached (a linear actuator). The variety of mechanical actuators and motors known in the art of engineering allows for wide ranges of application already, and often allows an engineer to select, not just an actuator that is capable of a given task, but a variety of actuator that can accomplish the desired motion most efficiently and with the least additional engineering.

However, the field of robotics, particularly practical robots that are useful in everyday applications instead of as scientific curiosities, is strictly limited by what can be done efficiently and cheaply with actuators as currently known in the art, namely by what available and affordable actuators happen to already be ‘good at’. It's known in the art to use a larger number or variety of actuators to attempt to engineer almost any motion, such as that of a human hand as with robot hands and prosthetics, but such implementations currently utilize dozens or hundreds of actuators that have to be carefully engineered to do a complicated task none of the actuators are actually designed to do well, which adds up to a steep price tag.

Often, this principle limits what kind of mobile robotic technology is available for ordinary people to use in their homes or businesses, favoring robots which are stationary (such as smart appliances) or which move on wheels (such as a robotic vacuum cleaner) over robots with articulated limbs or other forms of locomotion that require lots of actuators to build with the current technology available and are therefore more expensive and difficult to build. As an example, this is generally why there are affordable robots that vacuum, but none that fold laundry; one mode of motion is doable cheaply with simple motors that spin wheels, and the other isn't. A robot that walks, crawls, or scampers on individual limbs, or which uses arms or hands, is inefficient to build with the current available actuator technology.

Therefore, there is a long-felt need in the art of engineering and robotics to provide and make available further novel actuator implementations adapted to excel at different varieties of powered motion.

### SUMMARY OF THE INVENTION

Towards these and other objects of the method of the present invention (hereinafter, “the invented method”) that are made obvious to one of ordinary skill in the art in light of the present disclosure, an actuated or mobile device such as a mobile robot or robotic muscle is provided, wherein mobility may be enabled by means of novel models of inchworm actuator positioned to tighten, loosen, move, or pull on one or more strings (also called threads or tendons) to directly or indirectly effect motion. The one or more clamp elements of the inchworm actuator may include the novel optimization of being H-shaped. The mobility of the device may be effected by means of inchworm actuators tightening and/or loosening strings or tendons causing ‘foot’ elements to rotatably extend from or tuck into a surface of the device, enabling the device to pull itself along over a surface. The device may include one or more moveable joints implemented as a rigid arc frame and a string axis comprising bendable material shaped to bendably couple the arc frame to an opposite side of the joint such as a limb.

Inchworm actuators in general are a variety of “pulling” actuator that uses piezoelectric, electrostatic, magnetostriction, or similar motors to move a shaft with nanometer precision. The piezoelectric motors are activated in sequence to grip, extend, un-grip, and contract such that the shaft is moved along by an incremental ‘inching’ movement. The traditional view is that inchworm actuators excel at precision motions, able to measure the ‘inching’ motions down to the nanometer and start or stop very precisely. As generally known in the art, an inchworm actuator is fixed to a given spot and pulls on the shaft to change the position of the shaft relative to the fixed position of the actuator.

In preferred embodiments, the invented inchworm actuator as described herein is distinct in a few ways, and the system in which this invented inchworm actuator may be applied is counterintuitive to inchworm actuators as known in the art. For one, while most actuators would generally be mounted onto a single physical point of the machine being operated, such as with bolts or welding, the use of inchworm actuators in combination with tendonlike structures may allow the weight of the actuator to be supported entirely by the tension of the tendon(s), with no mounting of the actuator actually necessary. This may provide unprecedented flexibility of design, both in expansion of what can be designed and in the movement capabilities of the resulting machines.

As an example of this kind of system's value in an application such as robotic muscles, one might consider a similarity in design to biological muscles. In the human body, muscles produce force and motion by contracting and releasing, and in doing so pull on tendons, which connect muscles to bones and can be put under tension like a rubber band. One's fingers don't need much on-site muscle of their own (think how bulky that would be!) because muscles in the palm and forearm provide the power, pulling on tendons connected to the finger bones. Now, one might consider that the invented actuator provides force to effect motion by expanding and contracting to put tension on a stretchable tendon (which, in this case, might actually be a rubber band). For a large limb, bigger tendons or more tendon systems operating in parallel may be needed, but the basic concept is similar for a knee, an elbow, a facial muscle, or a finger.

In various preferred embodiments of the invention, the tendon component may be flexible or a greater or lesser degree, such as a cord, stretchy band, wire, or thin metal or plastic rod, as several non-limiting examples. Tendons as understood herein need not resemble anatomical tendons; the concept inspiring this terminology is more generally that of a structure that allows a muscle to pull on something located distantly using an intermediary structure, rather than requiring muscles or actuators to be positioned directly at a site of motion. For instance, the majority of muscles used for moving one's fingers are located in one's forearms, not in the fingers themselves; tendons connect these muscles to the bones of the fingers and allow those forearm muscles to effect finger motion. It is noted, regarding more sophisticated musculature in the field of robotics, that if one wants to mimic motion found in nature (such as that of a human hand, limb, or face), one might benefit from following the corresponding naturally-occurring engineering examples, instead of trying to approximate the same effect using the same motors one might use to turn wheels.

A first embodiment of the invented inchworm actuated device may comprise or include at least a body, at least one spring element coupling a front end of the body to a back end of the body, at least one piezoelectric linear actuator coupled to two or more H-shaped clamping elements, and one or more lengths of string or tendon positioned to be gripped by the clamps. It is noted that this combination of inchworm actuator and tendons may be featured as an actuating component of any number of devices, including the second embodiment device outlined below; however, the second embodiment outlined below includes many more novel features besides the actuation components, and this first embodiment is generalized to be any kind of device that includes this novel approach to actuation. The inchworm actuated device may shift the position of the length of string or tendon relative to the position of the device itself, such that (1.) if the device is fixed in place, the position of the string may be altered; (2.) if the string is anchored, such as at one or both ends, the device may move itself by pulling on the anchored string; and (3.) if both the device and the string are anchored, the string may be pulled taut or loosened by shortening or lengthening the slack of the string length between the fixed position of the device relative to the anchored point of the string. The inchworm actuated device pulls on the string to effect any of these motions, ‘inching’ along the string as the term ‘inchworm actuator’ implies, by performing the following basic steps in rotation: (1.) the frontmost clamp grips the string; (2.) the linear actuator causes the device body to extend (the grip point on the string is pulled along with the front of the device, and the spring element is stretched out); (3.) the rearmost clamp grips the string and the frontmost clamp releases; and (4.) the released spring element causes the device to contract (and the grip point on the string is pushed along with the rear of the device). It is noted that ‘front’ and ‘rear’ are relative terms, signifying either toward or away from the direction in which one intends to pull the string. It is noted how, in an implementation such as a robotic muscle, the string therefore functions similarly to an anatomical tendon, effecting motion by being tightened and loosened. The novel H shape of the clamping elements in this instance, combined with narrow clamping elements pushing outward to press the tendons into place between the ascenders and descenders of the H-shaped clamping elements, provides for holding the string, not just between two flat elements as with a standard non-H-shaped clamping element, but also pinching the string in the gap of space between the two ascenders and the two descenders of the H shape. This may provide better stability, reduce the force necessary to securely clamp the string in place, or provide other unexpected benefits. Further, the novel spring element may provide at least the benefit of faster contraction of the actuation device, providing a significantly faster and more efficient contraction motion over that of inchworm actuators as generally known in the art which may rely on a second motion of the piezoelectric stack for the same function.

Further preferred features and embodiments having an H-shaped clamp as mentioned herein, or a U-shaped clamp (i.e. only half of the H), may further include as an opposite clamping component a protruding ‘beak’ element which presses the string or tendon, not just against the H or U shaped clamp element, but into the gap(s) formed by the H or U shape. Since the tendon material may often be at least a little flexible, this may provide a more secure clamp grip by bending the tendon around the ‘beak’ element and causing the tendon to be gripped in two narrow places—namely against the beak on either side, instead of just against a broader clamp surface. If one considers gripping a string with one's fingers, rather than a tendon in a clamp, the benefit might be comparable mechanically to the difference between holding the string between two fingers as opposed to weaving the string through or around one's fingers.

A second embodiment of the invented inchworm actuated device may comprise or include at least a body having a front end and a rear end, one or more spring elements coupled such that a first end of the spring is attached to the front end and a second end of the spring is attached to the rear end, and one or more assemblies each comprising a linear actuator motor, two or more clamps coupled to the linear actuator motor and positioned to grip a paired set of strings or tendons, the strings each anchored at a first end of the device and anchored to either side of a leg rotator at the opposite end; the leg rotator substantively cylindrical, rotatably coupled to the front end or to the rear end of the device, and positioned such that tension on either length of string (provided by the linear actuator and clamps) causes the leg rotator to rotate clockwise or counterclockwise around a central axis of the cylindrical shape of the leg rotator; and a foot coupled to the leg rotator such that when the leg rotator is rotated (by tension on the strings), the attached foot is folded out (extended) or folded in (retracted). The device may utilize coordinated extension and retraction of two or more feet positioned on the front and/or rear sections of the device to engage/disengage with a surface the device is traversing. One readily apparent application is that the device may also practice the inchworm-pattern motion as explicated above: engage front, extend the springs coupling the front end to the rear end, engage the back and disengage the front, retract the springs. In this way, the invented device may inch along using relatively few and simple actuators, providing a powerful actuator or robotic device with a novel variety of movement, simplicity of design, affordability, scalability, and versatility suitable to a number of actuated and robotic applications that may heretofore have been considered impractical with previously available technology. A preferred example may include a robot or device equipped with a camera and suited for navigating into tight spaces by pushing with the above-mentioned legs against the sides of the narrow space, such as a small and/or flat model for inspecting behind heavy furniture or up a chimney, or an even smaller model that could climb into a plumbing pipe, potentially saving a specialist or handy-person hours of labor otherwise required to move the furniture or access the pipe.

A third embodiment of the invented actuated device may comprise or include at least one articulated mechanical joint or coupling in the fashion of a bow joint comprising a rigid arc and twistable or bendable string element. The name “bow joint” is derived from the structure's similarity in shape to a bow used to shoot an arrow: a rigid arc or frame, with a string coupled at either end onto each end of the arc. With an element such as a shaft coupled to the string, the shaft is permitted to rotate orthogonally to the string, around the string as a central point, until the shaft hits the arc, but restricted from other degrees of motion, such as parallel to or laterally along the string. One might compare this to the joint of one's knee: though the actual mechanical structure of the human knee is different, that structure also performs the function of permitting a specifically limited range of motion, such that one's knee bends well for walking or sitting, but can't be bent in the opposite direction, nor outward to one's left or right. The mechanical enforcement of a preferred range of motion may make the human leg substantially more structurally stable and easier to use for walking without injury. Similarly, the invented mechanical bow joint provides a flexible articulated mechanical joint, and also a means for mechanically limiting range of motion as preferred.

One potential application for the invented actuator device as explicated herein is in a bi-directional servo motor implementation, such as might be used in electromagnetic locks and valves, or for remotely opening/closing windows, gates, or doors. While many applications of the invented actuator device are possible, including some yet unanticipated, this is an example of a possibly less-obvious way in which this new technology may be utilized. In the preferred implementation, the invented actuator device is moving along and/or tightening tendons hooked onto two opposite ends of a linear frame possibly including a rail, such that the invented actuator device may pull on the tendons to move itself between one frame end and the other frame end, in appearance like a piston, according to control signals. For instance, the invented actuator device may be configured to move ‘up’ when the control signal is ON, and ‘down’ when the control signal is OFF, thus controlling also a lock, door, or other mechanical element connected to the actuating device. The invented actuator device may also function as a ‘fader’, rather than a binary on/off switch. The bi-directional servo motor application may further include a shaft element attached to the end of the invented actuator device, such that “on and off” correspond with extension and retraction of this physical element, in an application such as a deadbolt.

Yet another further application of the invented technology may be in a structure which utilizes the actuated motion of tendons pulled by the invented device to turn an axle or shaft (as with a turbine or wheel). This implementation might consist of a single invented actuator device rotatably coupled to an axle, such as by a ring-shaped element, with the tendons of the invented actuating device looped around the axle such that pulling on the tendons causes the axle to turn. If the axle is fixed in place and the actuator device is not, the same implementation might be suitable for allowing the actuating device to rotate itself around the axle by pulling on the tendons.

Parallel implementations of this rotary application, with several of the invented actuating devices rotatably coupled to the same axle and causing that axle to spin, are possible here. Running multiple actuators in parallel has at least the advantage of providing redundancy and increased force, such as for using the axle to move something heavy, as well as the ‘staggered re-spooling’ implementation discussed below. Further, this invented implementation for rotating an axle using the invented actuator device may be parallelized either by stacking multiple actuators in a line along the axle or by attaching multiple actuators to the same ring, causing the multiple actuators to be placed in a concentric arc or ring around the axle. A ‘star’ of actuators all the way around the same axle could be very powerful indeed, and further, one might do both, and form a ‘stacked star’.

This implementation might be considered a servo motor, as the available length of tendon is finite and this isn't ideal for continuous motion, such as spinning a wheel or turbine. However, one might precisely ‘program’ a certain amount of rotation by providing only enough tendon length to complete that amount. This also may be a good option for instances in which a significant amount of torque is required to perform a single movement. An example of this type of motion might be a batter swinging at a baseball: it's motion in an arc which has to be limited and precise (i.e. swinging too far is not preferred) but with a lot of torque and force.

Further, providing continuous motion might be achieved by having multiple actuators connected in a parallel implementation ‘take turns’ rewinding tendons while the other actuators continue to work, like a choir sustaining a long, continuous sound by the technique of individuals taking nonobvious breaths at different moments while the rest continue to sing.

Further, the structure of an instance of the invented actuator utilizing its tendons to rotate its own position relative to an axle may be an ideal structure for a robotic joint such as an elbow or knee, with the axle as the fulcrum point and an actuator to either side articulating the limb. Each side of the joint may also utilize multiple actuators in parallel. It is also possible to build a mechanical joint of this kind with more than one degree of freedom, by connecting two axles with a pole inbetween them, such that a first actuator turns around a first axle, a second actuator turns around a second axle, and the axles are connected.

Continuing with the concept of utilizing two or more invented actuators rotating their own positions about a mutual axle to form a robotic joint, one might assemble an entire robotic hand this way, as disclosed herein, and the scalability of the invented actuators and tendons allows for a less bulky, cheaper, nimbler, and more dexterous implementation of a robotic hand than is generally expected or known in the art. It is noted that the use of inchworm actuators to tense and release tendon elements, as well as other elements disclosed herein, represents a unique and novel approach to actuated robotic motion, including that of robotic limbs, that may easily distinguish the robotic hands explicated herein from ‘robot hands’ as a generally understood concept. Many previous implementations of robotic hands in particular, which generally require dexterity, have struggled with fitting in bulky actuators that are ill-suited to the task, and which requiring lots of actuators carefully engineered to achieve the desired motion capabilities. The invention or inventions disclosed herein are believed to be a far better approach to this known problem, one that entirely eliminates much of the bulk, cost, difficulty, and delay that has generally characterized previous attempts at engineering robotic manual dexterity.

Yet another novel application of the invented actuator may be in pivoting a clawlike element to extend and retract. With a single invented actuator coupled with tendons to rotate and axle, and the axle further coupled to a clawlike appendage, the actuator may pivot the axle, and therefore fold or extend the claw appendage. This may be useful in particular for building a robot whose tasks necessitate the ability to climb. A few anticipated applications for such a climbing robot may include roof maintenance and power line maintenance.

Regarding suitable materials for constructing the invented device, the invented device may be constructed of any material deemed suitable by one skilled in the art as presently considered or discovered in the future to be suitable, including but not limited to plastics, wood, metal, rubber, synthetic polymers, and similar. In certain preferred embodiments, the string or tendon elements might be implemented from a composite material such as a composite material with ability to dissolve a part of material the way that only hard part may be left. For example, a rectangular string might contain two plastic or metal string and a filler. During the printing process all parts are in place, but then a part of material can be dissolved or removed by high temperature.

One skilled in the art recognizes that certain elements must be rigid, other elements must be flexible or twistable, other elements must conduct electricity, and may perceive other such practical limitations as stated herein regarding the individual elements, and that those practicalities may further limit the set of appropriate materials for certain specific elements from that which is listed here, or compel one to utilize a variety of a suggested material that suits the practical limitation concerned, such as using soft plastic instead of hard plastic as appropriate, or a metal that is more malleable rather than less as appropriate.

It is understood that this statement and any other regarding preferred or possible materials is not intended as a limitation, and is offered only as additional guidance in constructing an instance of the invention in an optimal fashion as understood presently by the inventor.

Specifically regarding preferred or suitable piezoelectric components for implementation of the invented actuator, it is noted that the invented design includes mechanical amplification of the displacement of the PZT stack through leverage, and that preferred qualities for a PZT stack in this context may include a displacement of 0.1%-0.2% and ability to provide a relatively strong force. While the model being utilized for building a prototype is the PK2FVF1 Amplified Piezoelectric Actuator, 75 V, 420 μm, as manufactured by Thorlabs, Inc. of New Jersey, USA, it should be noted that this is an example of a piezoelectric actuator that is considered merely adequate for demonstrating and illustrating the basic concept. A preferred model of PZT actuator would be smaller, lighter, and may be a custom design particular to the implementations described herein.

It is understood that any measurements given herein as to the size or scale of the invented devices disclosed herein pertains only to the examples given, and does not constitute a limitation regarding size or scale of the invention. The invented devices disclosed herein may be substantially scalable, making both very small and very large embodiments entirely possible and potentially useful depending upon the intended application. It is understood that the invented components presented herein are scalable, and indeed, benefits of this novel approach include the possibility of making very small functional embodiments utilizing the same principles. Any sizes or measurements included in this disclosure should be viewed as presenting of functional examples, rather than construed as limitations. This disclosure should not be construed as insisting upon or specifying any particular size or scale of the invention.

Preferred embodiments of the invention may be or include an apparatus comprising: a tensile element, the tensile element substantively inelastic along a traction axis, the tensile element comprising a first end and a second end; and an expandable means coupled with the tensile element by means of a coupling element wherein the tensile element is pinched by pressing of a length of the tensile element into a U-shaped gap, the expandable means adapted to expand and thereby deliver a force to the tensile element, the force initially being normal to the traction axis, whereby the force is transferred from the expandable means to the tensile element and causes the tensile element to exert force along the traction axis.

Further additional preferred embodiments of the invention may be or include an apparatus comprising: a device front end, a device rear end, at least one spring element coupling the device front end extendably to the device rear end, and at least one assembly comprising: a cylindrical element coupled rotatably to a selected device end selected from either the device front end or the device rear end, and coupled also to a protruding element, whereby an extension of the protruding element is increased and decreased by rotation of the cylindrical element around a central axis of the cylindrical element; a first tensile element (“the first string”) substantively inelastic along a first traction axis and comprising a first string first end and a first string second end, wherein the first string first end is coupled to the cylindrical element whereby pulling on the first string rotates the cylindrical element clockwise, and the first string second end is anchored to a device end opposite the selected device end coupled to the cylindrical element; a first expandable means coupled with the first string, the first expandable means adapted to expand and thereby deliver a force to the first string, the force initially being normal to the first traction axis, whereby the force is transferred from the first expandable means to the first string and causes the first string to exert force along the first traction axis and pull the cylindrical element to rotate clockwise; a second tensile element (“the second string”) substantively inelastic along a second traction axis and comprising a second string first end and a second string second end, wherein the second string first end is coupled to the cylindrical element whereby pulling on the second string rotates the cylindrical element counterclockwise, and the second string second end is anchored to the device end opposite the selected device end coupled to the cylindrical element; and a second expandable means coupled with the second string, the second expandable means adapted to expand and thereby deliver a force to the second string, the force initially being normal to the second traction axis, whereby the force is transferred from the second expandable means to the second string and causes the second string to exert force along the second traction axis and pull the cylindrical element to rotate counterclockwise.

Further additional preferred embodiments of the invention may be or include an apparatus comprising at least one articulated joint coupling, the articulated joint coupling comprising: a first side of the articulated joint coupling comprising a rigid arc with a first arc end and a second arc end; a string element with a first string end coupled to the first arc end and a second string end coupled to the second arc end; and a second side of the articulated joint coupling coupled to a point on the string element between the first string end and the second string end.

Further additional preferred embodiments of the invention may be or include a clamping apparatus for clamping a bendable string, the clamping apparatus comprising at least a first side, the first side shaped to include a gap positioned between a first column and a second column; a second side, the second side shaped to include a protruding element positioned to sit between the first column and the second column when the clamp is engaged, such that when the clamp is engaged, the bendable string is forced into the gap between the first column and the second column, and around the protruding element.

Further additional preferred embodiments of the invention may be or include a bidirectional servo motor utilizing the invented actuators as described above, which might be utilized as an actuated locking mechanism or similar.

Further additional preferred embodiments of the invention may be or include an axle torque servo motor utilizing embodiments of the invented device, wherein the force exerted by the tensile element either turns and axle or rotates the position of the device around an axle. This embodiment in particular may be utilized in an assembly comprising two axle torque servo motors oriented around the same axle, each able to pivot its own position relative to the axle, forming a movable robotic joint. Further, a variation of this robotic joint having two degrees of motion instead of one, may consist of an assembly comprising a first axle torque servo motor rotating itself around a first axle, and a second axle torque servo motor rotating itself around a second axle, the first axle and the second axle coupled together by a post, forming a movable robotic joint having two degrees of motion. A robotic hand with fingers might be constructed utilizing multiple instances of either of these movable robotic joints. A robotic claw could be made, comprising the axle torque servo motor with a claw-shaped element coupled to the axle, such that rotating the axle unfolds or retracts the claw, which might be suitable for constructing a climbing robot which can use these claws to grip and climb as a cat does.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

The present disclosure incorporates by reference the two registered US Patents and one US Provisional Patent Application, in their entirety and for all purposes, of U.S. Pat. Reg. No. 10,422,359, issued on Sep. 24, 2019, and titled TENSILE ACTUATOR; U.S. Pat. Reg. No. 10,920,800, issued on Feb. 16, 2021, and titled TENSILE ACTUATOR; and U.S. Patent Application Appn. Ser. No. 63/158,859, filed on Mar. 9, 2021 and titled INCHWORM ACTUATOR.

The above-cited US Patents and Provisional Patent Application are incorporated herein by reference in their entirety and for all purposes.

### BRIEF DESCRIPTION OF DRAWINGS

The detailed description of some embodiments of the invention is made below with reference to the accompanying figures, wherein like numerals represent corresponding parts of the figures.

FIG. 1A is a first line drawing of an invented prototype actuator device with tendons belonging to a first embodiment of the invented device;

FIG. 1B is a diagram presenting further information about the clamping elements and tendon motion of the device of FIG. 1A;

FIG. 2 is a second line drawing of the invented actuator device of FIG. 1A;

FIG. 3 is a third line drawing of the invented actuator device of FIG. 1A;

FIG. 4 is a 3D model of the invented actuator device of FIG. 1A without tendons included;

FIG. 5 is a 3D model providing a view of the invented actuator device of FIG. 4 from an additional angle;

FIG. 6 is a 3D model of the invented actuator device of FIG. 1A in a partially-assembled state with the clamp elements partially removed to show other elements;

FIG. 7 is a 3D model providing a view of the partially-assembled invented actuator device of FIG. 6 from an additional angle;

FIG. 8 is a 3D model providing a view of the first embodiment of the invented device in the partially-assembled state of FIG. 6 as viewed from a third additional angle;

FIG. 9 is a 3D model of the frame and clamp elements of the first embodiment of the invented device;

FIG. 10 is the 3D model of the frame element of FIG. 9 at a different angle and without the clamps;

FIG. 11 is the 3D model of the frame element of FIG. 10 at an additional different angle;

FIG. 12 is a 3D model of the first embodiment of the invented device of FIG. 4 in a partially-assembled state, with the frame of FIG. 9 and the H-shaped clamp holders removed to view other elements;

FIG. 13 is a 3D model providing a view of the first embodiment of the invented device in the partially-assembled state of FIG. 12 as viewed from an additional angle;

FIG. 14 is a 3D model providing a view of the first embodiment of the invented device in the partially-assembled state of FIG. 12 as viewed from a second additional angle;

FIG. 15 is a 3D model of a clamp element of FIG. 4 presented separately;

FIG. 16 is a line drawing of the frame element of FIG. 9 coupled together with three H-shaped clamping elements, with a fourth H-shaped clamping element removed to display;

FIG. 17 is a line drawing of the frame element of FIG. 17 coupled together with the four H-shaped clamping elements;

FIG. 18 is a line drawing presenting a prototype device representing a second embodiment of the invention;

FIG. 19 is a second line drawing presenting an additional view of the device of FIG. 18;

FIG. 20 is a third line drawing presenting an additional view of the device of FIG. 18;

FIG. 21 is a fourth line drawing presenting an additional view of the device of FIG. 18;

FIG. 22 is a fifth line drawing presenting an additional view of the device of FIG. 18;

FIG. 23 is a line diagram representation of the tendon structure of the second embodiment of FIG. 18;

FIG. 24A is a first line diagram presenting a method of folding and unfolding robot legs by means of a couple of pulling actuators of FIG. 23, wherein the leg is folded in;

FIG. 24B is a second line diagram presenting the leg of FIG. 24A now in an extended position;

FIG. 25 is a line diagram of a system similar to those of FIGS. 24A and 24B, showing how the same two actuators may be further utilized to pull on more strings and thus operate two legs instead of just one;

FIG. 26 is a line drawing presenting a first mechanical joint with one degree of motion belonging to a third embodiment of the invention;

FIG. 27 is a line drawing presenting the mechanical joint of FIG. 26 in a rotated position;

FIG. 28 is a 3D model presenting the string component of the mechanical joint of FIG. 26 in a perspective view;

FIG. 29 is a 3D model presenting the string component of FIG. 28 in a top view;

FIG. 30 is a 3D model presenting the string component of FIG. 28 in a side view;

FIG. 31A is a line drawing presenting the mechanical joint of FIG. 26 in a partially-bent position;

FIG. 31B is a line drawing presenting the mechanical joint of FIG. 26 bent to approximately a 90 degree angle;

FIG. 31C is a line drawing presenting the mechanical joint of FIG. 26 in an unbent position;

FIG. 32 is a line drawing presenting a second mechanical joint having two degrees of motion belonging to the third embodiment of the invention;

FIG. 33 is a line drawing presenting an additional view of the second mechanical joint of FIG. 32;

FIG. 34 is a line drawing presenting an additional view of the second mechanical joint of FIG. 32, bended into a position demonstrating the flexibility of the mechanical joint;

FIG. 35 is a 3D model presenting a perspective view of the flexible element of the second mechanical joint of FIG. 32;

FIG. 36 is a 3D model presenting a top view of the flexible element of FIG. 35;

FIG. 37 is a 3D model presenting a side view of the flexible element of FIG. 35;

FIG. 38A is a first 3D model view of a beak feature for potential use in clamping assemblies of various embodiments such as but not limited to the invented actuator device of FIG. 1A;

FIG. 38B is a second 3D model view of a beak feature for potential use in clamping assemblies of various embodiments such as but not limited to the invented actuator device of FIG. 1A;

FIG. 38C is a third 3D model view of a beak feature for potential use in clamping assemblies of various embodiments such as but not limited to the invented actuator device of FIG. 1A;

FIG. 39A is a 3D model of a bi-directional servo motor implementation utilizing an embodiment of the invented actuator device of FIG. 1A;

FIG. 39B is the 3D model of the bi-directional servo motor of FIG. 39A, presented from a first additional viewing angle;

FIG. 39C is the 3D model of the bi-directional servo motor of FIG. 39A, presented from a second additional viewing angle;

FIG. 39D is the 3D model of the bi-directional servo motor of FIG. 39A, presented from a third additional viewing angle;

FIG. 40A is a 3D model of an axle-rotation servo motor implementation utilizing an embodiment of the invented actuator device of FIG. 1A;

FIG. 40B is a diagram similar to that of FIG. 1B, pertaining to the axle-rotation servo motor implementation of FIG. 40A;

FIG. 40B is a diagram presenting more information about the internal mechanics of the axle-rotation servo motor implementation of FIG. 40A;

FIG. 40C is a first possible cross-section of the frame element of FIG. 40A;

FIG. 40D is a second possible cross-section of the frame element of FIG. 40A;

FIG. 41 is a 3D model of four of the axle-rotation servo motor implementation of FIG. 40A set up to work in parallel along the same axle;

FIG. 42A is a 3D model of three of the axle-rotation servo motor implementation of FIG. 40A set up to work in parallel oriented around the same axle in a partial arc;

FIG. 42B is a first different angle of the 3D model of FIG. 42A;

FIG. 42C is a second different angle of the 3D model of FIG. 42A;

FIG. 43 is a 3D model of multiple of the axle-rotation servo motor implementation of FIG. 40A set up to work in parallel oriented around the same axle in a full orbit forming a star shape;

FIG. 44 is a 3D model of multiple of the axle-rotation servo motor implementation of FIG. 40A, parallelized both around the same axle as in FIG. 43 and along the same axle as in FIG. 41, forming a stacked star shape;

FIG. 45 is a 3D model presenting an implementation of an artificial joint utilizing two of the axle-rotation servo motors of FIG. 40A;

FIG. 46A is a 3D model presenting an implementation of an artificial joint utilizing two parallelized sets of the axle-rotation servo motors of FIG. 42A;

FIG. 46B is a different angle of the 3D model of FIG. 46A;

FIG. 46C is a 3D model presenting an implementation of an artificial joint utilizing two stacked parallelized sets of the axle-rotation servo motors of FIG. 46A, in the manner of FIG. 44;

FIG. 47A is a 3D model presenting an implementation of an artificial joint having two degrees of freedom, utilizing two of the axle-rotation servo motors of FIG. 40A;

FIG. 47B is a different angle of the 3D model of FIG. 47A;

FIG. 47C is a closer view of the 3D model of FIG. 47B;

FIG. 48A is a first view of a 3D model presenting a robotic hand implemented using axle-rotation servo motor joints as presented in FIG. 46A and onward;

FIG. 48B is a second view of the 3D model robotic hand of FIG. 47A;

FIG. 48C is a third view of the 3D model robotic hand of FIG. 47A;

FIG. 49A is a profile view of a claw assembly implemented utilizing the axle torque assembly of FIG. 40A, with the claw folded in;

FIG. 49B is a profile view of the claw assembly of FIG. 49A, with the claw folded out;

FIG. 49C is a top view of the claw assembly of FIG. 49A, with the claw folded in;

FIG. 50A is a first view of a robot utilizing multiple instances of the claw assembly of FIG. 49A for climbing; and

FIG. 50B is a second view of a robot utilizing multiple instances of the claw assembly of FIG. 49A for climbing.

### DETAILED DESCRIPTION OF DRAWINGS

In the following detailed description of the invention, numerous details, examples, and embodiments of the invention are described. However, it will be clear and apparent to one skilled in the art that the invention is not limited to the embodiments set forth and that the invention can be adapted for any of several applications.

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims. Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

Throughout this specification, like reference numbers signify the same elements throughout the description of the figures.

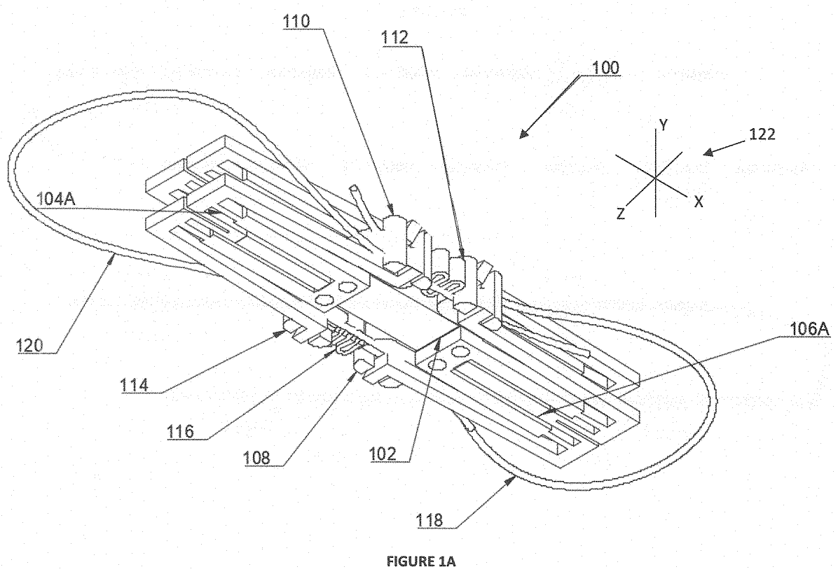

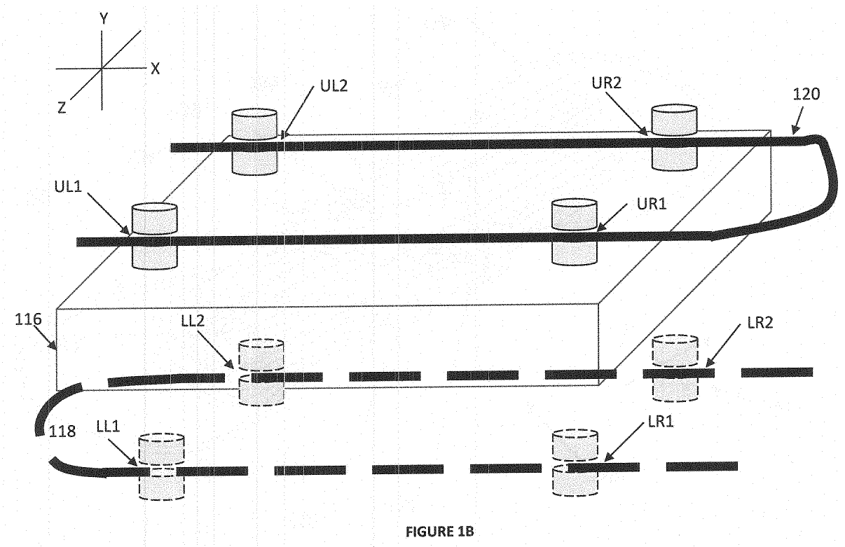

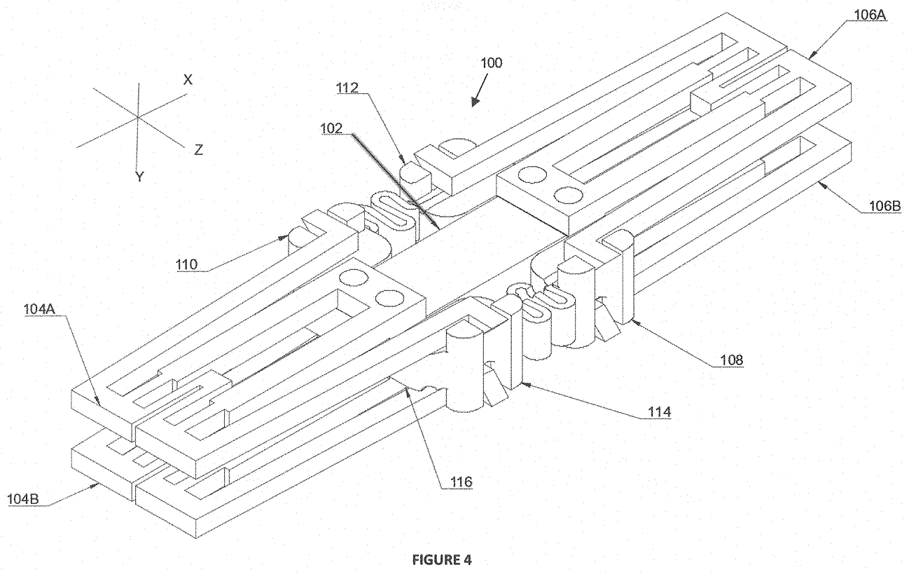

Referring now generally to the Figures and particularly to FIG. 1A, FIG. 1A is a first line drawing of an invented prototype actuator device with tendons, belonging to a first embodiment of the invented device. A first device 100 as pictured here comprises a piezoelectric stack 102; a set of clamping elements 104-114 comprising a first upper inner clamp element 104A, a second upper inner clamp element 106A (these elements are duplicated on the opposite side of the device to the camera, and aren't visible in this image, namely a first lower inner clamp element 104B and a second lower inner clamp element 106B as presented in FIG. 4), a first outer clamp element 108, a second outer clamp element 110, a third outer clamp element 112, a fourth outer clamp element 114; and a frame 116. The clamping elements 104-114 are positioned to controllably grip and release a first tendon 118 and a second tendon 120 (“the tendons 118 & 120”), as a result of being pushed on or released by the piezoelectric stack 102. It is noted that a piezoelectric material is a material that expands in volume in response to receiving an electrical current; therefore, the piezoelectric stack 102 can be controlled to expand by applying an electrical current, and by this expansion engages the clamping elements 104-114 by pressing against the first upper inner clamp element 104A, the first lower inner clamp element 104B (shown in FIG. 4), the second upper inner clamp element 106A, and the second lower inner clamp element 106B (shown in FIG. 4), forcing these elements out toward the first outer clamp element 108, the second outer clamp element 110, the third outer clamp element 112, and the fourth outer clamp element 114, and trapping the first tendon 118 and the second tendon 120 between inner and outer clamping elements. Preferred implementation of this device 100 is as a tandem inchworm actuator comprising multiple coordinated lanes.

Certain Figures presented throughout further include a compass 122, wherein an X axis, a Y axis, and a Z axis are each mutually orthogonal to one another. As these pertain to the presented devices in the various Figures, the Y axis parallels the vertical dimension of up-and-down (i.e. the top and bottom of the device), the X-axis parallels the dimension of forward-and-back (i.e. along the tendons or direction of travel if any), and the Z-axis parallels the dimension of side-to-side. It is noted that some images are top or profile views, and may therefore only show two axes, not three, with the third not visible as it may be ‘pointed toward the viewer’.

Referring now generally to the Figures and particularly to FIG. 1B, FIG. 1B is a diagram presenting more information about the orientation and operation of the clamping elements 104-114 in interaction with the tendons 118 & 120. In FIG. 1A, the clamping elements were named as components of the device 100, specifically as outer pieces and inner pieces capable of being forced together to clamp down on the tendons 118 & 120 at the points where the outer pieces and inner pieces meet. In FIG. 1B, the discussion turns to these clamping points, and how engaging and releasing of these clamping points produces inchworm actuator motion with the tendons 118 & 120. This diagram includes a set of eight clamping points UL1-LR2 (“the clamping points UL1-LR2”): a first upper left clamping point UL1 engaged by the compressing of the first upper inner clamp element 104A against the fourth outer clamp element 114; a second upper left clamping point UL2 engaged by the compressing of the first upper inner clamp element 104A against the second outer clamp element 110; a first lower left clamping point LL1 engaged by the compressing of the first lower inner clamp element 104B (shown in FIG. 4) against the fourth outer clamp element 114; a second lower left clamping point LL2 engaged by the compressing of the first lower inner clamp element 104B (shown in FIG. 4) against the second outer clamp element 110; a first upper right clamping point UR1 engaged by the compressing of the second upper inner clamp element 106A against the first outer clamp element 108; a second upper right clamping point UR2 engaged by the compressing of the second upper inner clamp element 106A against the third outer clamp element 112; a first lower right clamping point LR1 engaged by the compression of the second lower inner clamp element 106B against the first outer clamp element 108; and a second lower right clamping point LR2 engaged by the compression of the second lower inner clamp element 106B (shown in FIG. 4) against the third outer clamp element 112. It is understood that ‘left’, ‘right’, ‘upper’, ‘lower’, ‘first’, and ‘second’ are all arbitrary designations of these components, intended for distinguishing elements of interest and providing as much clarity as possible. It is noted that the device 100 might be oriented differently, such as turning the device around such that all of the ‘left’ elements are placed on the viewer's right-hand side, and nothing would actually change about the device 100.

In the diagram of FIG. 1B, each of the clamping points UL1-LR2 as listed above is represented as a pair of cylinders on either side of one of the tendons 118 & 120, indicating a point at which that tendon may be clamped. It is noted that, in actual operation of the device 100 as presented in FIG. 1A, this clamping generally occurs on either side of the device 100, not on the top and bottom (unless of course one rotates the device to orient the sides as the top and bottom), and the clamping action is generally sideways and outward from the device 100. It is noted that other embodiments of the invented device 100 may implement clamps oriented differently, and that this is more of a clarification regarding the appearance of this diagram as mapped onto the photo of FIG. 1A, than any indication of a limitation. Further, while visual representations herein present components such as clamps as having certain shape or structure, it is also understood that these may vary broadly. One skilled in the art will recognize that there are many shapes of clamp available that would be suitable but are not presented herein, and that the art may further innovate to construct a clamping mechanism ideal for this purpose. One notes that, while inchworm actuators use clamping to effect motion, the means of clamping does not ‘matter’ to the actuator as long as the clamp works. The diagram of FIG. 1B is intended to present the functionality of the clamping points UL1-LR2, not necessarily to present the physical structure of the clamp mechanisms accurately. As presented here, the first tendon 118 fits through and is clamped by the ‘lower’ group of clamping points, specifically, LL1, LL2, LR1, and LR2; and the second tendon 120 fits through and is clamped by the ‘upper’ group of clamping points, specifically, UL1, UL2, UR1, and UR2.

In preferred operation, the device 100 is controlled by supplying power selectively to the piezoelectric stack 102, causing the piezoelectric stack 102 to expand and contract, pushing against the inner clamping elements 104A, 104B, 106A, and 106B and thus engaging and disengaging the clamping points UL1-LR2. A possible pattern of states for effecting motion is as follows:

| | UL | UR | LL | LR | Body | | |
|---|---|---|---|---|---|---|---|
| Zero | + | + | + | + | holds the position | | |
| LEFT1 | − | + | − | + | not moving | \| | |
| LEFT2 | − | + | − | + | extends | \| | Repeating 4 steps |
| LEFT3 | + | − | + | − | not moving | \| | continuously until |
| LEFT4 | + | − | + | − | contracts | \| | reaching the position |
| Zero | + | + | + | + | holds the position | | |
| Right1 | + | − | + | − | not moving | | |
| Right2 | + | − | + | − | extends | | |
| Right3 | − | + | − | + | not moving | | |
| Right4 | − | + | − | + | contracts | | |

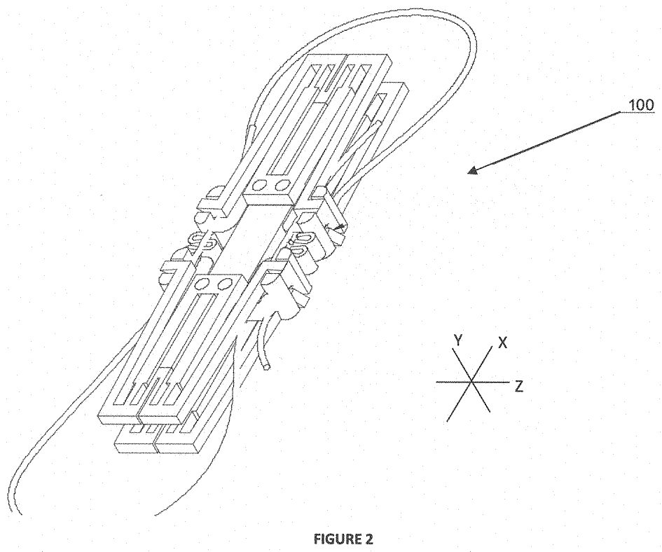

Referring now generally to the Figures and particularly to FIG. 2, FIG. 2 is a second line drawing of the invented actuator device of FIG. 1.

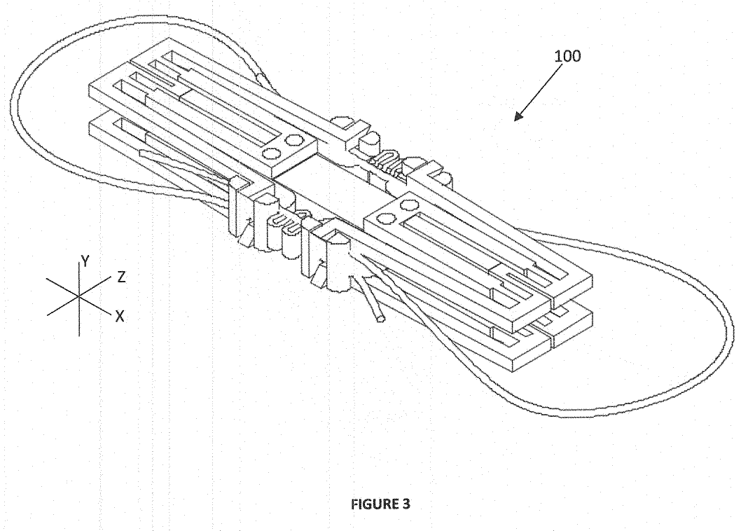

Referring now generally to the Figures and particularly to FIG. 3, FIG. 3 is a third line drawing of the invented actuator device of FIG. 1.

Referring now generally to the Figures and particularly to FIG. 4, FIG. 4 is a 3D model of the invented actuator device of FIG. 1A, no longer presenting the first tendon 118 and the second tendon 120. All of the elements mentioned previously are also labeled here for reference between FIG. 1A and this Figure, namely the first device 100 comprising the piezoelectric stack 102; the set of clamping elements 104-114 comprising the first upper inner clamp element 104A, the second upper inner clamp element 106A the first lower inner clamp element 104B, the second lower inner clamp element 106B, the first outer clamp element 108, the second outer clamp element 110, the third outer clamp element 112, the fourth outer clamp element 114; and the frame 116. In FIG. 4, the X-axis as shown indicates the length dimension of the first device 100; the Y axis indicates the height dimension of the first device 100; and the Z-axis indicates the width dimension of the first device 100. The first device 100 as shown here may be built to be any size considered feasible and appropriate for desired application. The width of the first device 100 may be in the range of from less than one inch to over twelve inches; the length of the first device 100 may be in the range of from less than one inch to over twelve inches; and the height of the first device 100 may be in the range of from less than one inch to over twelve inches.

Referring now generally to the Figures and particularly to FIG. 5, FIG. 5 is a 3D model providing a view of the invented actuator device of FIG. 4 from an additional angle.

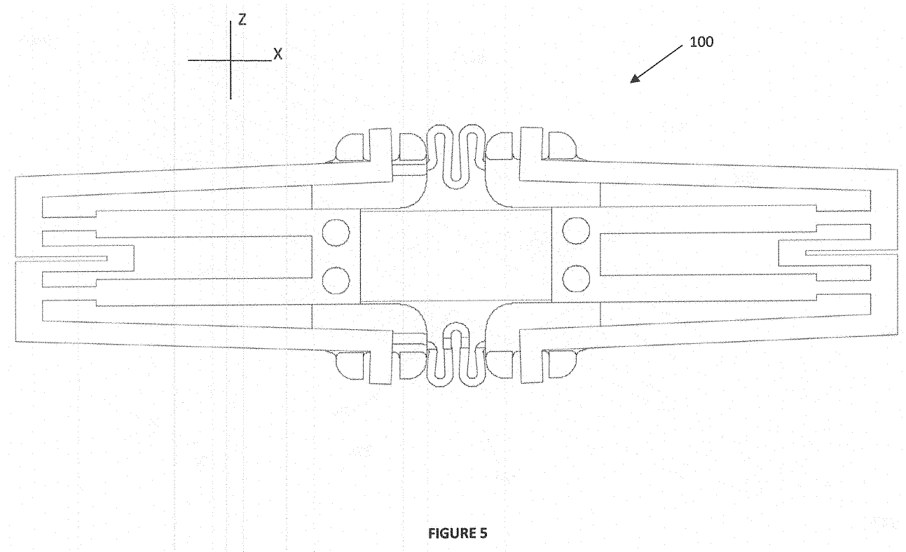

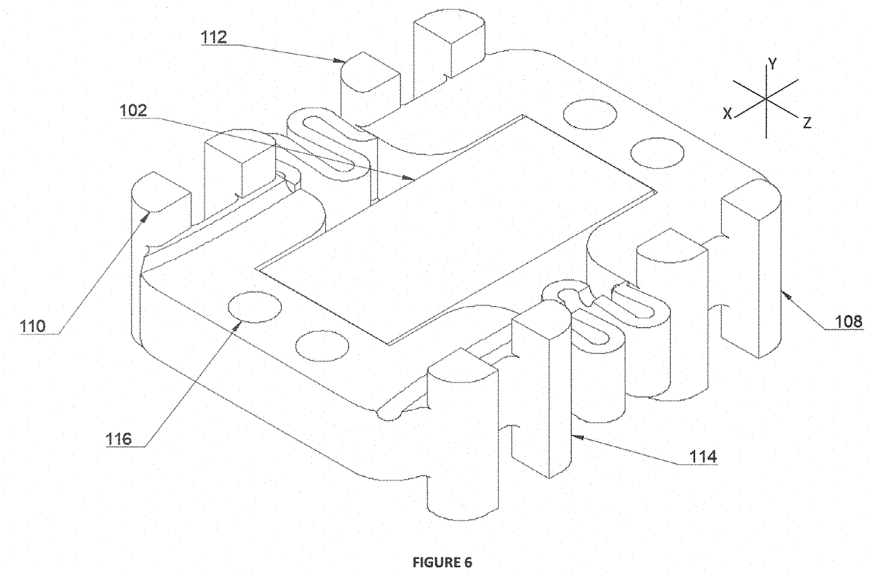

Referring now generally to the Figures and particularly to FIG. 6, FIG. 6 is a 3D model of the invented actuator device of FIG. 1A in a partially-assembled state with the clamp elements partially removed to show other elements. Particularly, the piezoelectric stack 102, the first outer clamp element 108, the second outer clamp element 110, the third outer clamp element 112, the fourth outer clamp element 114, and the frame 116 are present, and the first upper inner clamp element 104A, the second upper inner clamp element 106A the first lower inner clamp element 104B, the second lower inner clamp element 106B are omitted from this image to more clearly present other elements of the assembly such as the shape of the frame 116.

Referring now generally to the Figures and particularly to FIG. 7, FIG. 7 is a 3D model providing a view of the partially-assembled invented actuator device of FIG. 6 from an additional angle.

Referring now generally to the Figures and particularly to FIG. 8, FIG. 8 is a 3D model providing a view of the first embodiment of the invented device in the partially-assembled state of FIG. 6 as viewed from a third additional angle.

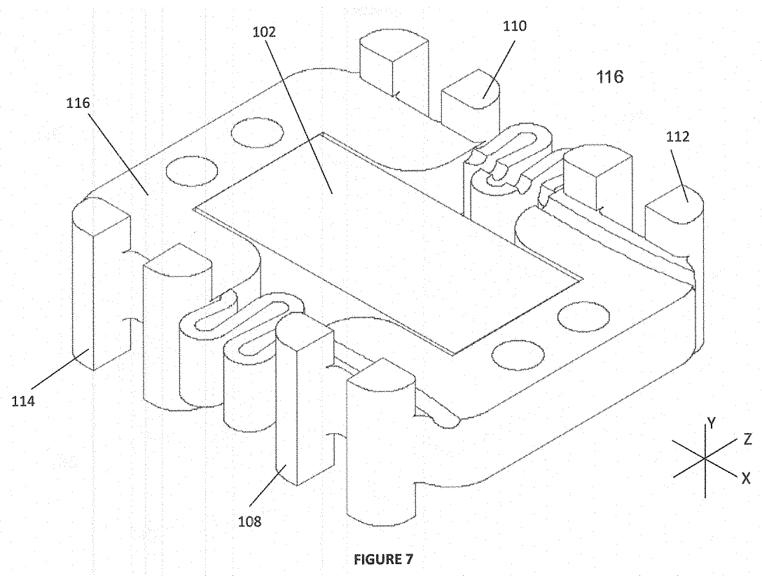

Referring now generally to the Figures and particularly to FIG. 9, FIG. 9 is a 3D model of the frame 116 of the first embodiment of the invented device.

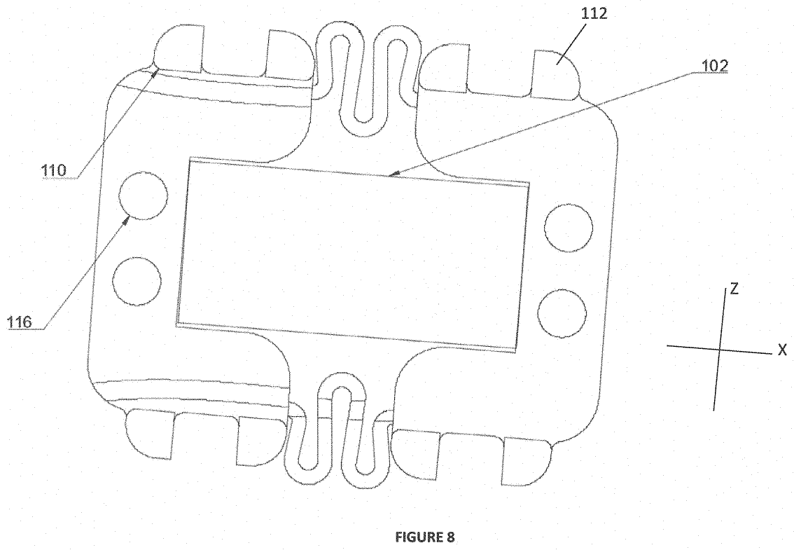

Referring now generally to the Figures and particularly to FIG. 10, FIG. 10 is the 3D model of the frame 116 of FIG. 9 at a different angle.

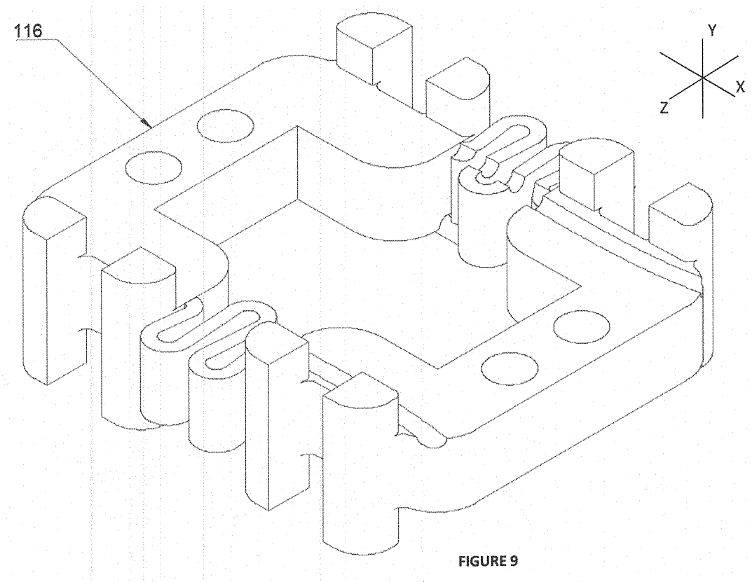

Referring now generally to the Figures and particularly to FIG. 11, FIG. 11 is the 3D model of the frame 116 of FIG. 9 at an additional different angle.

Referring now generally to the Figures and particularly to FIG. 12, FIG. 12 is a 3D model of the first embodiment of the invented device of FIG. 4 in a partially-assembled state, including the piezoelectric stack 102, the first upper inner clamp element 104A, the second upper inner clamp element 106A the first lower inner clamp element 104B, and the second lower inner clamp element 106B. The first outer clamp element 108, the second outer clamp element 110, the third outer clamp element 112, the fourth outer clamp element 114, and the frame 116 are omitted to present the shown elements more clearly, including how the first upper inner clamp element 104A, the second upper inner clamp element 106A the first lower inner clamp element 104B, and the second lower inner clamp element 106B are fitted close to the piezoelectric stack 102 such that expansion of the volume of the piezoelectric stack 102 would push on the first upper inner clamp element 104A, the second upper inner clamp element 106A the first lower inner clamp element 104B, and the second lower inner clamp element 106B, causing these in turn to push outward.

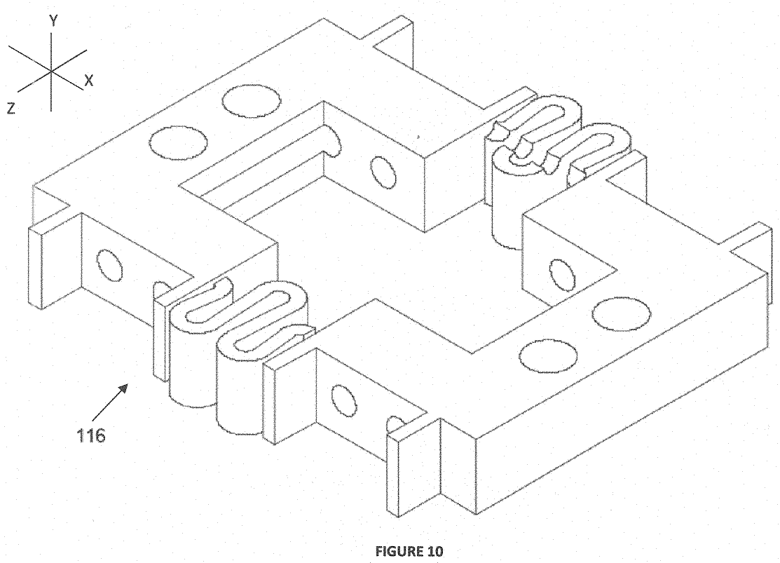

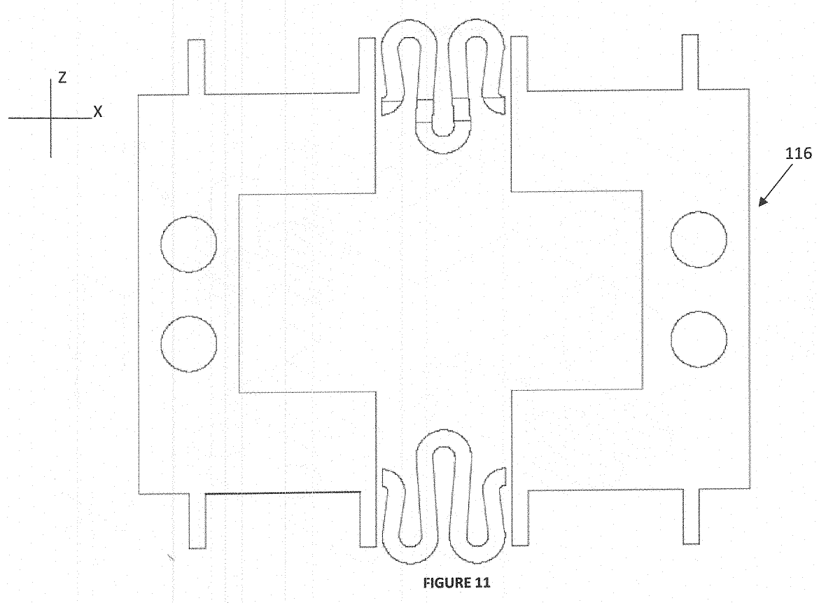

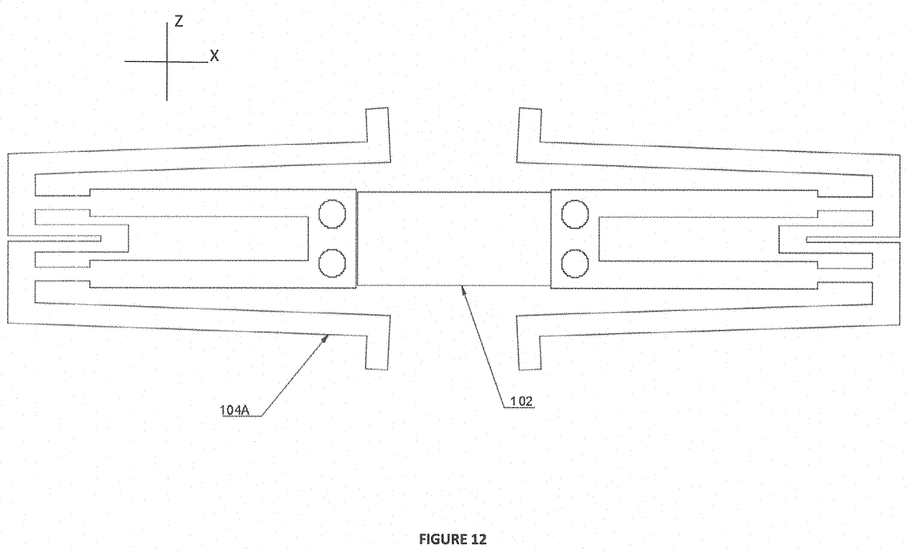

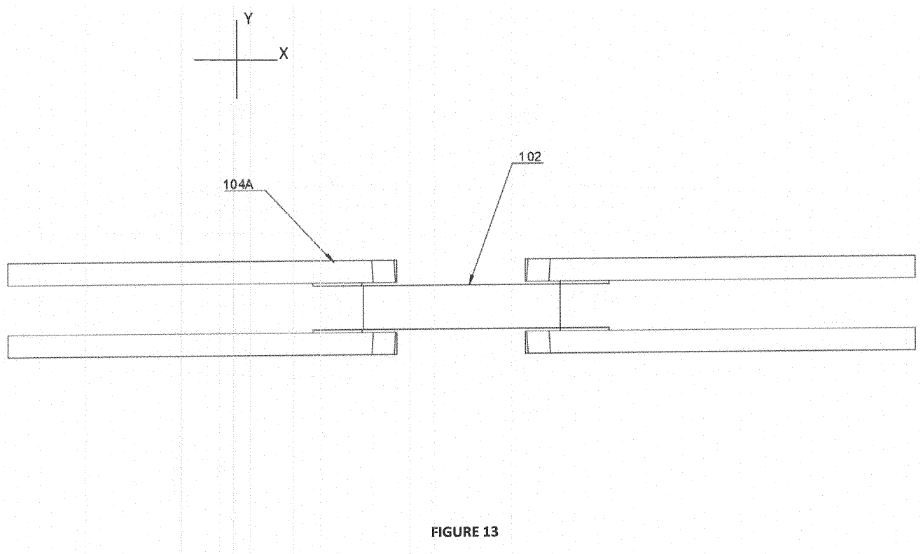

Referring now generally to the Figures and particularly to FIG. 13, FIG. 13 is a 3D model providing a view of the first embodiment of the invented device in the partially-assembled state of FIG. 12 as viewed from an additional angle.

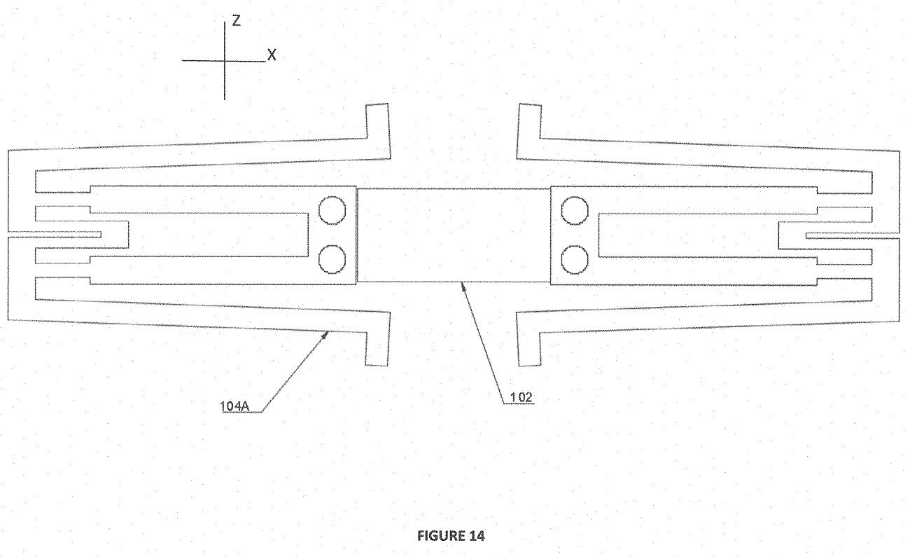

Referring now generally to the Figures and particularly to FIG. 14, FIG. 14 is a 3D model providing a view of the first embodiment of the invented device in the partially-assembled state of FIG. 12 as viewed from a second additional angle.

Referring now generally to the Figures and particularly to FIG. 15, FIG. 15 is a 3D model of an inner clamp element of FIG. 4 such as the first upper inner clamp element 104A, the second upper inner clamp element 106A the first lower inner clamp element 104B, or the second lower inner clamp element 106B, presented separately to show the shape of this element. It is noted that, in preferred embodiments, the first upper inner clamp element 104A, the second upper inner clamp element 106A the first lower inner clamp element 104B, and the second lower inner clamp element 106B are duplicates of the same component, and the only distinction between these may be their positioning on the device. It is further noted that, while this may be a convenient approach if all four elements are intended to perform the same task in different positions, this is not a compulsory limitation and an embodiment wherein like elements of the device 100 may not be completely or even remotely identical might provide some further benefit if this seems appropriate to one skilled in the art who may be making an embodiment of the device.

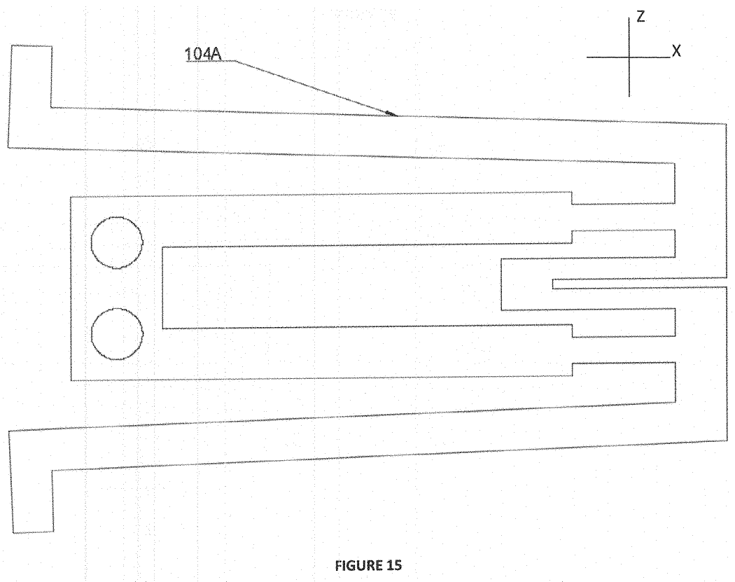

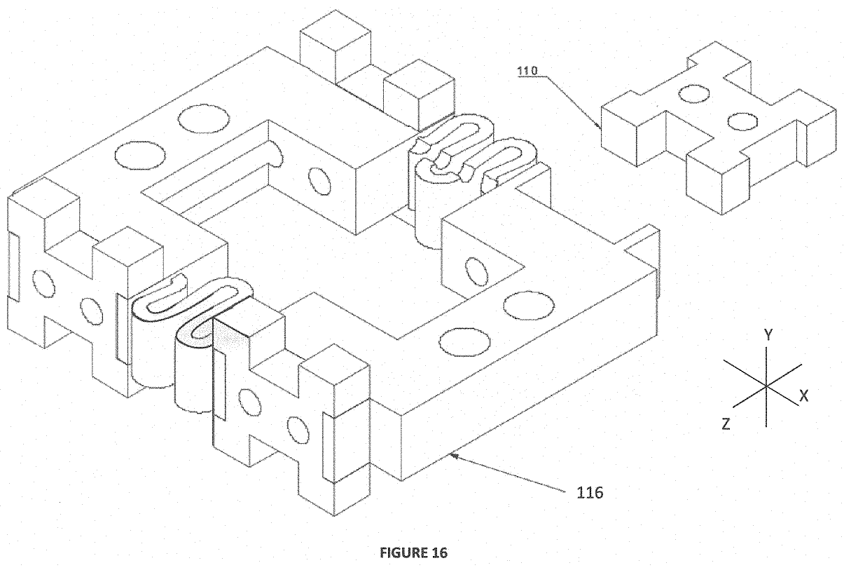

Referring now generally to the Figures and particularly to FIG. 16, FIG. 16 is a line drawing of the frame 116 of FIG. 9 coupled together with the first outer clamp element 108, the fourth outer clamp element 114, and the third outer clamp element 112, with the second outer clamp element 110 uncoupled from the frame 116 to present this element in isolation.

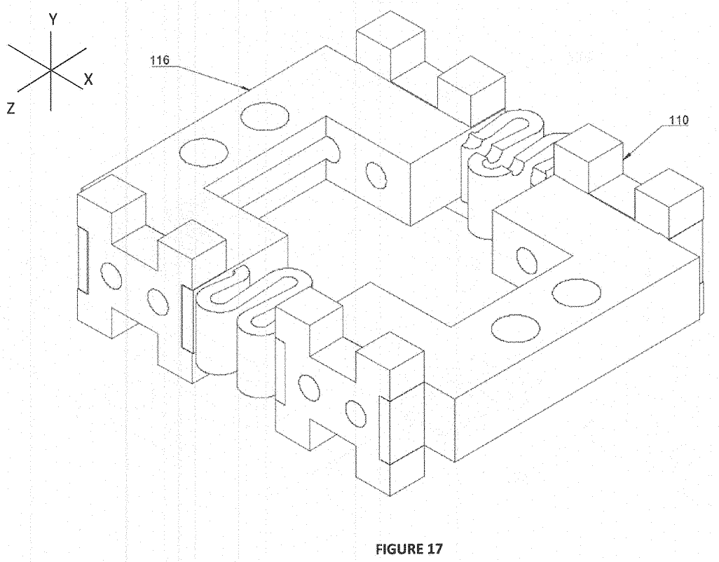

Referring now generally to the Figures and particularly to FIG. 17, FIG. 17 is a line drawing of the frame element of FIG. 17 coupled together with the first outer clamp element 108, the second outer clamp element 110, and the third outer clamp element 112, and the fourth outer clamp element 114.

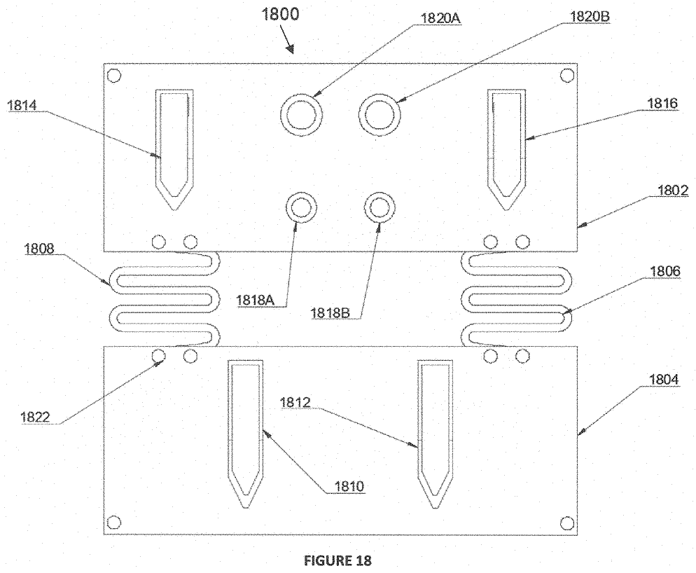

Referring now generally to the Figures and particularly to FIG. 18, FIG. 18 is a line drawing presenting a prototype device 1800 representing a second embodiment of the invention. It is understood that size is not a limitation of the invention, and any measurement presented herein is solely for the purposes of clear disclosure by concrete example. Particularly, it is noted that a device this small and lightweight that can propel itself without the use of wheels or similar is relatively novel, and the possible applications myriad. One apparent application may be controlled locomotion into tight spaces, such as behind or underneath heavy furniture that would otherwise have to be physically moved in order to inspect a wall or fixture; a camera or other sensor on the device may allow for any necessary inspection to be done remotely. The device 1800 as pictured here includes a front end 1802, a rear end 1804, a right spring 1806, a left spring 1808, a left rear leg 1810, a right rear leg 1812, a left front leg 1814, a right front leg 1816, a first button 1818A, a second button 1818B, a first sensor 1820A, and a camera 1820B. It is noted that placement, quantity, or variety of sensors, cameras, and controls such as buttons may differ or vary as preferred. The device 1800 further includes a plurality of bolts 1822 coupling components of the device 1800 securely together; it is additionally noted that a means other than bolting could be used to accomplish this, and that if bolting is preferred, the bolts or screws used may be of any suitable variety as known in the art. In this image, the front left leg 1814 is in a retracted position, the front right leg 1816 is in a retracted position, the left rear leg 1810 is in an extended position, and the right rear leg 1812 is in an extended position.

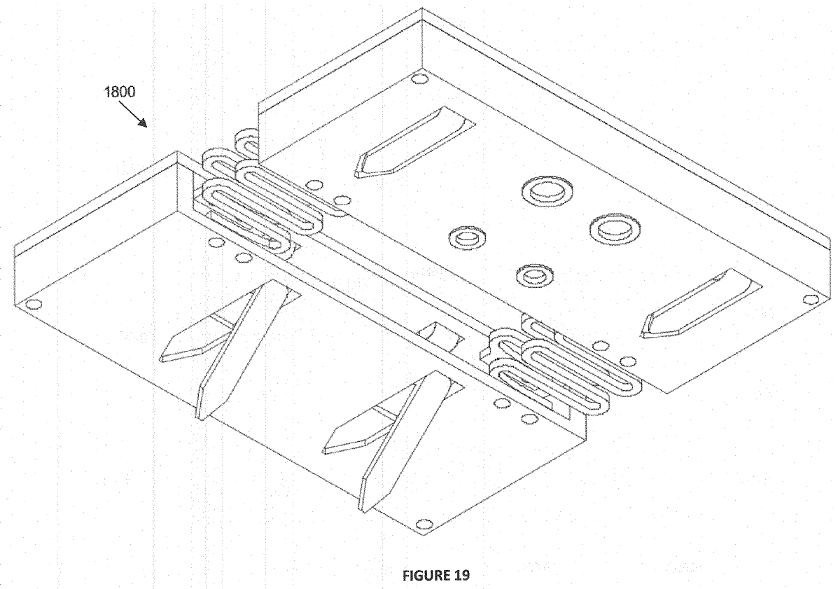

Referring now generally to the Figures and particularly to FIG. 19, FIG. 19 is a second line drawing presenting an additional view of the device of FIG. 18.

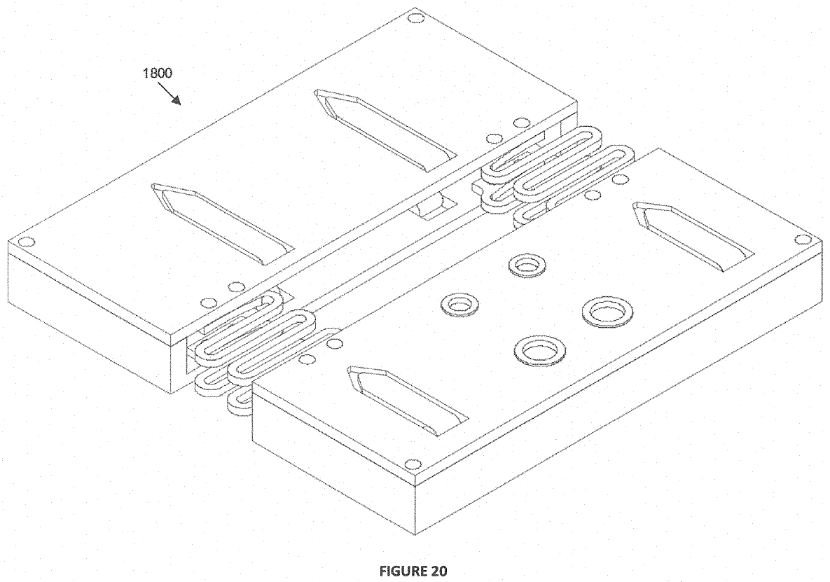

Referring now generally to the Figures and particularly to FIG. 20, FIG. 20 is a third line drawing presenting an additional view of the device of FIG. 18.

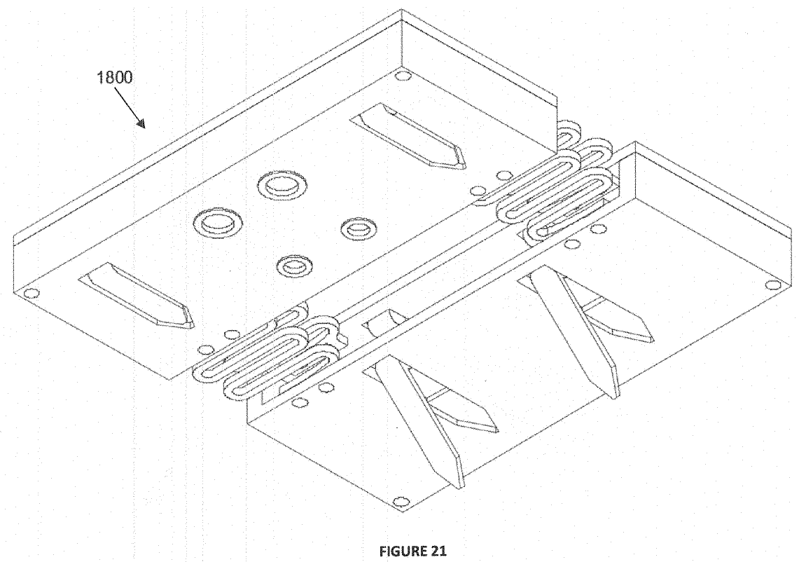

Referring now generally to the Figures and particularly to FIG. 21, FIG. 21 is a fourth line drawing presenting an additional view of the device of FIG. 18.

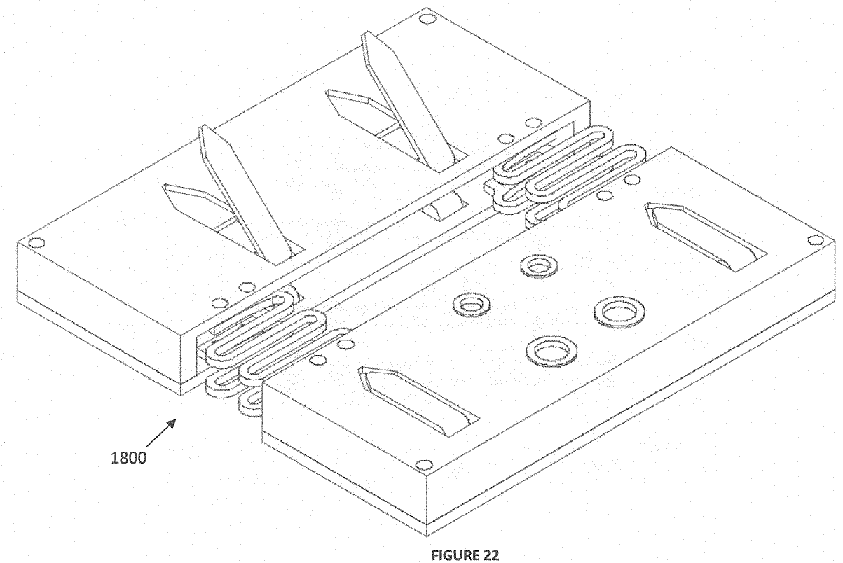

Referring now generally to the Figures and particularly to FIG. 22, FIG. 22 is a fifth line drawing presenting an additional view of the device of FIG. 18.

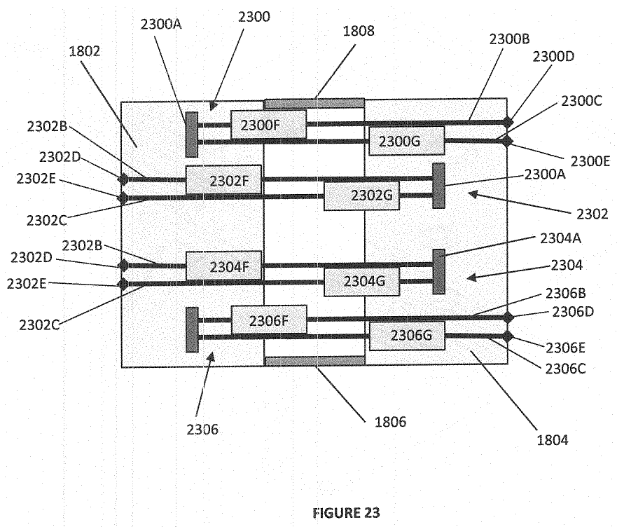

Referring now generally to the Figures and particularly to FIG. 23, FIG. 23 is a line diagram representation of the tendon structure of the second embodiment of FIG. 18, presenting key internal elements that power the front left leg 1814, the front right leg 1816, the left rear leg 1810, and the right rear leg 1812 to extend and retract. This drawing represents the front end 1802, the rear end 1804, the left spring 1806, the right spring 1808, and further diagrams a set of four tendon assemblies 2300-2306, namely a first tendon assembly 2300, a second tendon assembly 2302, a third tendon assembly 2304, and a fourth tendon assembly 2306, each of these controlling the movement of a leg 1810-14 as selected from the front left leg 1814, the front right leg 1816, the left rear leg 1810, and the right rear leg 1812. The first tendon assembly 2300 comprises a first roller 2300A, a first up string 2300B, a first down string 2300C, a first up anchor point 2300D, a first down anchor point 2300D, a first up actuator 2300F, and a first down actuator 2300G. The first roller 2300A is directly coupled to the front right leg 1816 and rotatably to the front end 1802, such that when the first roller 2300A is rolled in one direction, the front right leg 1816 extends, and when the first roller 2300A is rolled in an opposite direction, the front right leg 1816 retracts. The first up string 2300B is coupled to the first roller 2300A at a first end of the first up string 2300B, and anchored at the first up anchor point 2300C, such that the first up string 2300B can be put under tension between the first roller 2300A and first up anchor point 2300C, and such that when the first up string 2300B exerts force on the first roller 2300A, such as by the first up string 2300B having been pulled in the direction of the first up anchor point 2300C, the first roller 2300A is rotated such that the front right leg 1816 retracts (or is pulled ‘up’, hence ‘up string’ as differentiating terminology). The first up actuator 2300F can be controlled to pull on the first up string 2300B and increase the tension of the first up string 2300B; certain of the actuator varieties mentioned herein and disclosed in some of Applicant's previous patents incorporated herein by reference might be ideal for this implementation. Similarly, the first down string 2300C is coupled to the first roller 2300A and at the first down anchor point 2300E, and the first down actuator 2300G is positioned to pull on the first down string 2300C, increase the tension of the first down string 2300C between the first down anchor point 2300E and the first roller 2300A, causing the first roller 2300A to roll in a direction opposite to that of the first up string 2300B, thus causing the front right leg 1816 to retract. It is noted that, if there is an actuator device that is capable of simultaneously controlling both strings as required to perform the functions of extending and retracting the front right leg 1816, the first up actuator 2300F and the first down actuator 2300G might be combined as a single actuator. Regardless, the number and complexity of mechanisms required to implement this effect is notably modest. Similarly, the second tendon assembly 2302 consists of a second roller 2302A, a second up string 2302B, a second down string 2302C, a second up anchor point 2302D, a second down anchor point 2302E, a second up actuator 2302F, and a second down actuator 2302G, and controls the extension and retraction of the right rear leg 1812 in accordance with the method recited above pertaining to the first tendon assembly 2300. Similarly, the third tendon assembly 2304 consists of a third roller 2304A, a third up string 2304B, a third down string 2304C, a third up anchor point 2304D, a third down anchor point 2304E, a third up actuator 2304F, and a third down actuator 2304G, and controls the extension and retraction of the left rear leg 1810 in accordance with the method recited above pertaining to the first tendon assembly 2300. Similarly, the fourth tendon assembly 2306 consists of a fourth roller 2306A, a fourth up string 2306B, a fourth down string 2306C, a fourth up anchor point 2306D, a fourth down anchor point 2306E, a fourth up actuator 2306F, and a fourth down actuator 2306G, and controls the extension and retraction of the left front leg 1814 in accordance with the method recited above pertaining to the first tendon assembly 2300.

Referring now generally to the Figures and particularly to FIG. 24A, FIG. 24A is a first line diagram visually presenting the method recited above, wherein the first tendon assembly 2300 operates the right front leg 1816. This diagram presents the right front leg 1816 in a retracted position.

Referring now generally to the Figures and particularly to FIG. 24B, FIG. 24B is a second line diagram visually presenting the method recited above, wherein the first tendon assembly 2300 operates the right front leg 1816. This diagram presents the right front leg 1816 in an extended position.

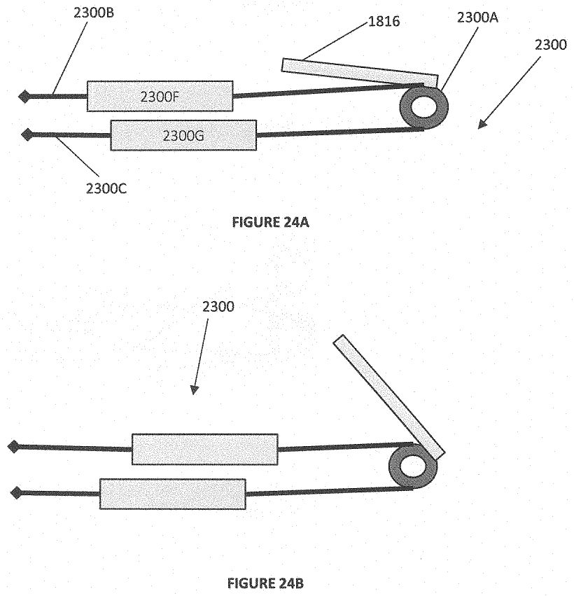

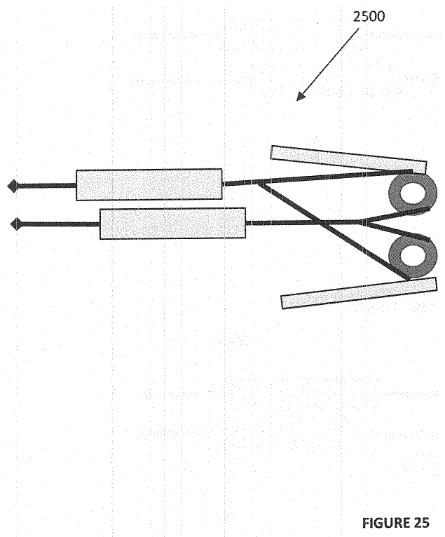

Referring now generally to the Figures and particularly to FIG. 25, FIG. 25 is a line diagram of a two-foot assembly 2500 which is similar to those of FIGS. 24A and 24B, showing how the same two actuators of a single tendon assembly 2300-2306 of FIGS. 23, 24A, and 24B may be further utilized to pull on additional strings and thus operate two legs instead of just one. It is noted that this may be a suitable implementation in an application where the two legs controlled by the same tendon assembly 2300-2306 may constructively move in tandem and need not move independently of each other.

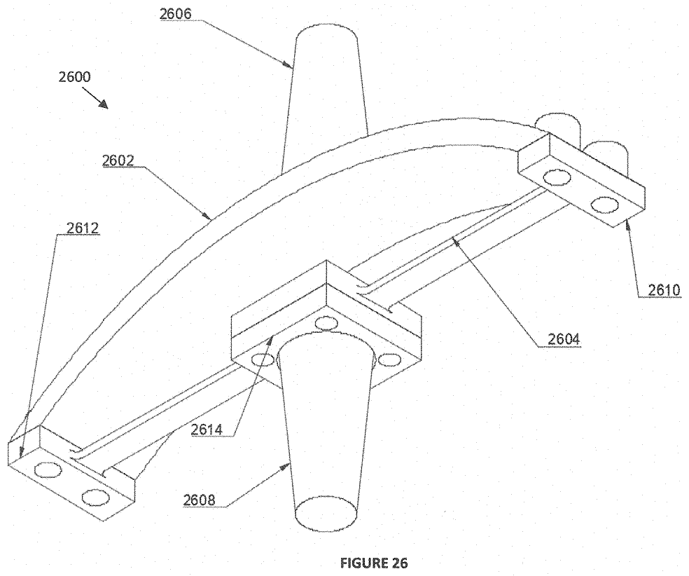

Referring now generally to the Figures and particularly to FIG. 26, FIG. 26 is a line drawing presenting a first invented mechanical joint 2600 (“the first joint 2600”) with one degree of motion belonging to a third embodiment of the invention. The first joint 2600 comprises at least a rigid arc 2602, a string element 2604, a bow side 2606, a non-bow side 2608, a first fastening point 2610, a second fastening point 2612, and a middle fastening point 2614. As subsequent Figures will make clear, the first joint 2600 comprises a flexible coupling of the bow side 2606 to the non-bow side 2608, similar to how one's elbow is a flexible coupling of one's upper arm (humerus) to one's lower arm (radius and ulna). Other elements may be further coupled onto the bow side 2606 or non-bow side 2608 elements shown, but in this image, these are represented minimally. The string element 2604 is coupled at either end to either end of the rigid arc, namely the first fastening point 2610 and the second fastening point 2612. A point at the middle of the string element 2604, namely the middle fastening point 2614, is fastened in turn to the non-bow side 2608. This fastening is, in this instance, done with small bolts; other means of fastening are possible, obvious, and may be preferred in other assemblies. The first joint 2600 as shown here may be built to be any size considered feasible and appropriate for desired application. The width of the first joint 2600 may be in the range of from less than one inch to over twelve inches; the height of the first joint 2600 may be in the range of from less than one inch to over twelve inches; and the depth of the first joint 2600 may be in the range of from less than one inch to over twelve inches.

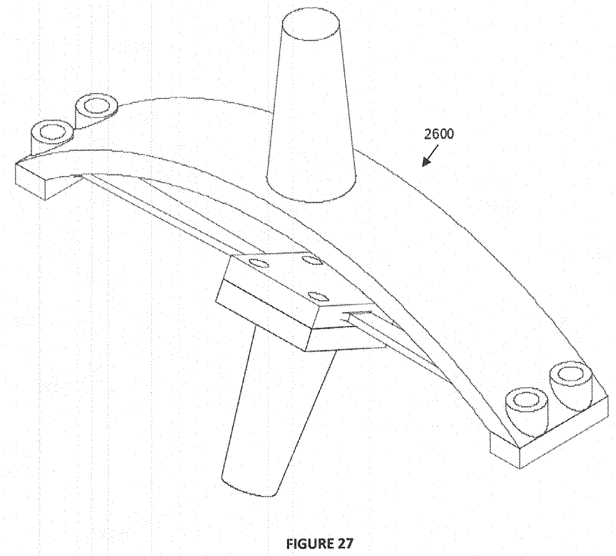

Referring now generally to the Figures and particularly to FIG. 27, FIG. 27 is a line drawing presenting the mechanical joint of FIG. 26 in a rotated position. The non-bow side 2608 is permitted to rotate, twisting the string element 2604, but is only mechanically capable of rotating in one dimension, namely in line with the bow side 2606, and could not rotate very far sideways, out toward the first fastening point 2612 or the second fastening point 2614. Thus, the first joint 2600 is mechanically adapted for facilitating articulated motion within a specified degree of freedom but not others.

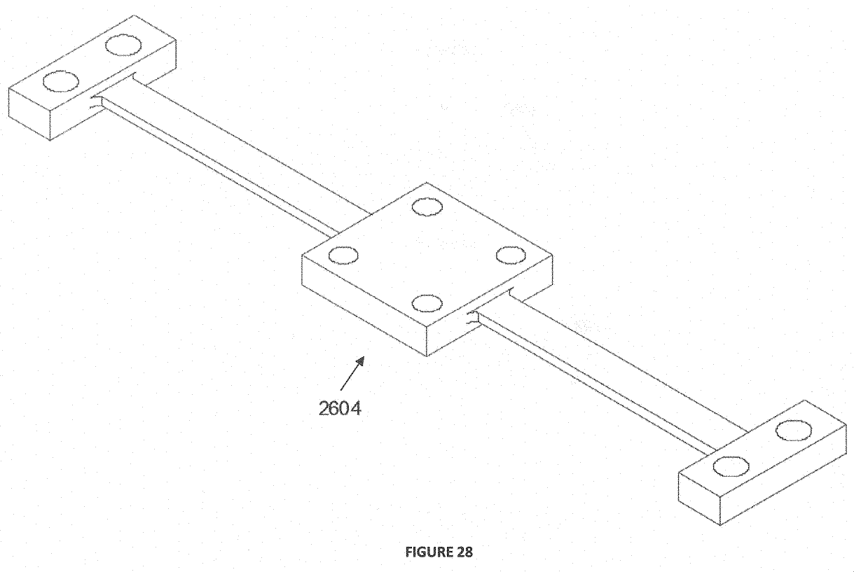

Referring now generally to the Figures and particularly to FIG. 28, FIG. 28 is a 3D model presenting the string element 2604 of the mechanical joint of FIG. 26 in a perspective view.

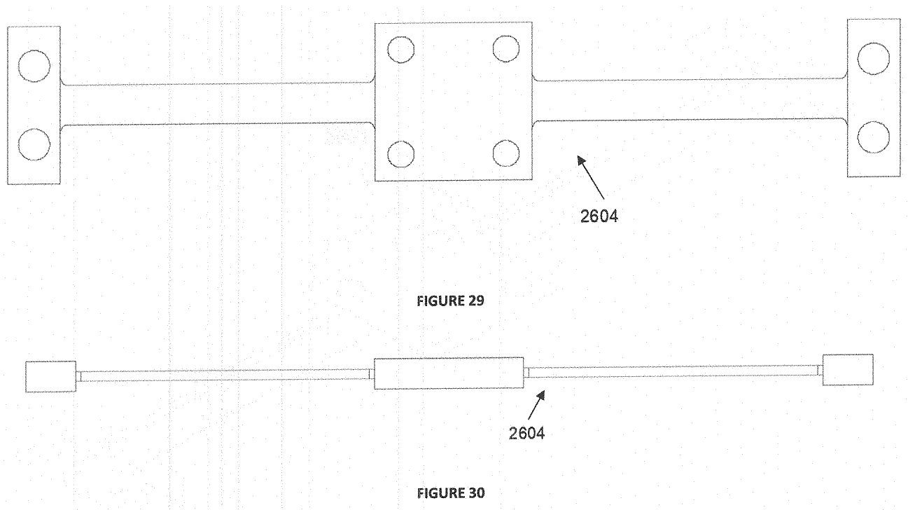

Referring now generally to the Figures and particularly to FIG. 29, FIG. 29 is a 3D model presenting the string element 2604 of FIG. 28 in a top view.

Referring now generally to the Figures and particularly to FIG. 30, FIG. 30 is a 3D model presenting the string component of FIG. 28 in a side view.

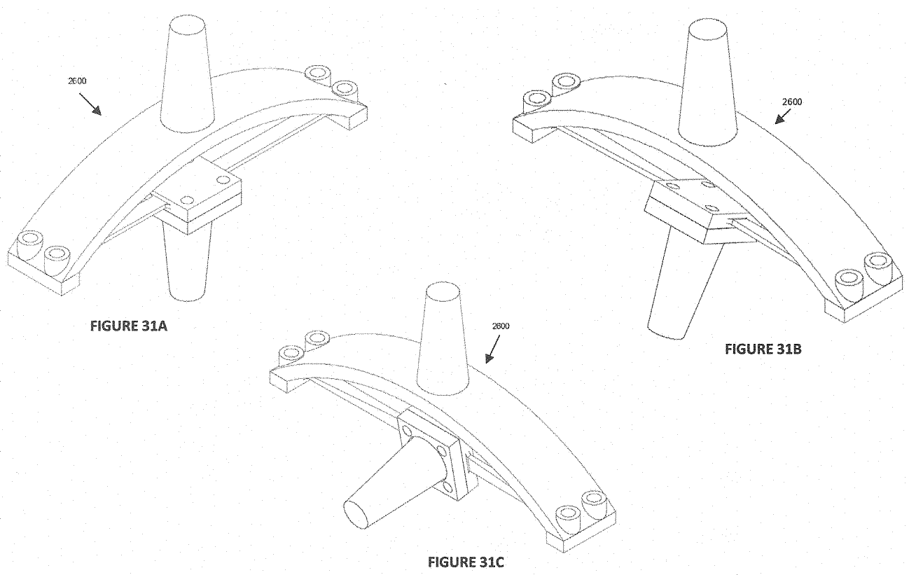

Referring now generally to the Figures and particularly to FIG. 31A, FIG. 31A is a line drawing presenting the mechanical joint of FIG. 26 in a partially-bent position.

Referring now generally to the Figures and particularly to FIG. 31B, FIG. 31B is a line drawing presenting the mechanical joint of FIG. 26 bent to approximately a 90 degree angle.

Referring now generally to the Figures and particularly to FIG. 31C, FIG. 31C is a line drawing presenting the mechanical joint of FIG. 26 in an unbent position.

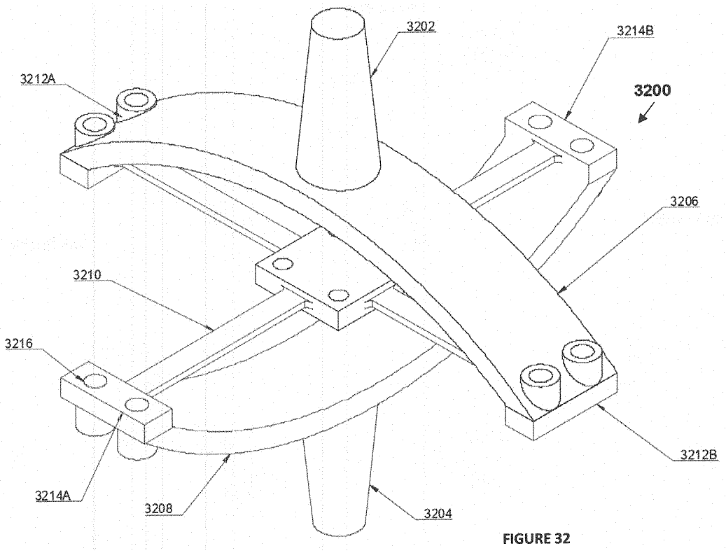

Referring now generally to the Figures and particularly to FIG. 32, FIG. 32 is a line drawing presenting a second mechanical joint 3200 (“the second joint 3200”) having two degrees of motion, belonging to the third embodiment of the invention. The second joint 3200 comprises a first arc side 3202, a second arc side 3204, a first rigid arc 3206, a second rigid arc 3208, a four-way string element 3210, a first arc first fastening point 3212A, a first arc second fastening point 3212B, a second arc first fastening point 3214A, a second arc second fastening point 3214B, and a plurality of fastening means 3216, bolts in this instance, providing fastening at the above-mentioned fastening points. The positioning of the first rigid arc 3206, the second rigid arc 3208, and the four-way string element 3210 permits the second joint 3200 two degrees of freedom of motion, instead of the one degree of motion of the first joint 2600.

Referring now generally to the Figures and particularly to FIG. 33, FIG. 33 is a line drawing presenting an additional view of the second mechanical joint of FIG. 32.

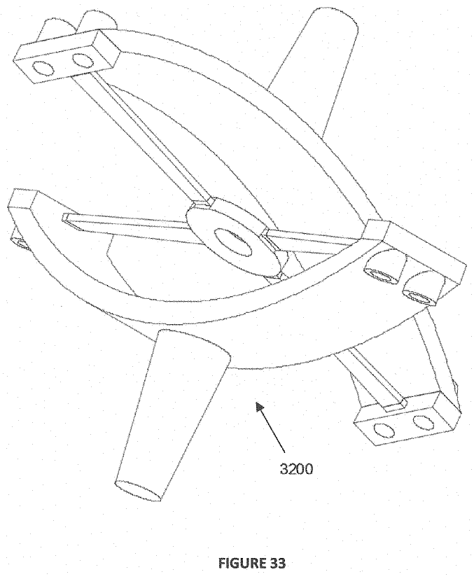

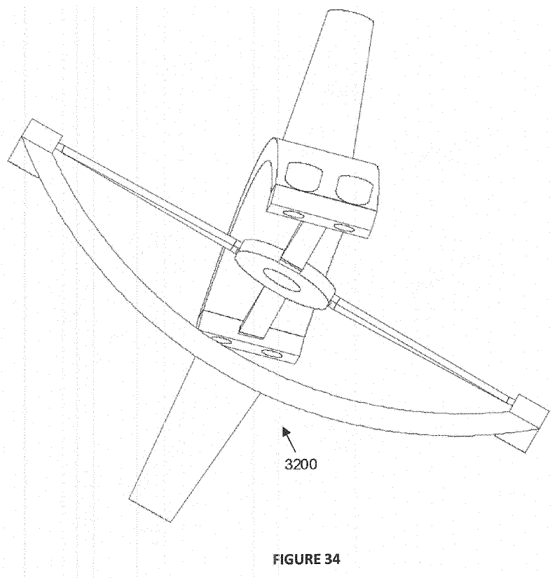

Referring now generally to the Figures and particularly to FIG. 34, FIG. 34 is a line drawing presenting an additional view of the second joint 3200 of FIG. 32, bended into a position demonstrating the flexibility of the second joint 3200.

Referring now generally to the Figures and particularly to FIG. 35, FIG. 35 is a 3D model presenting a perspective view of the four-way string element 3210 of the second joint 3200 of FIG. 32.

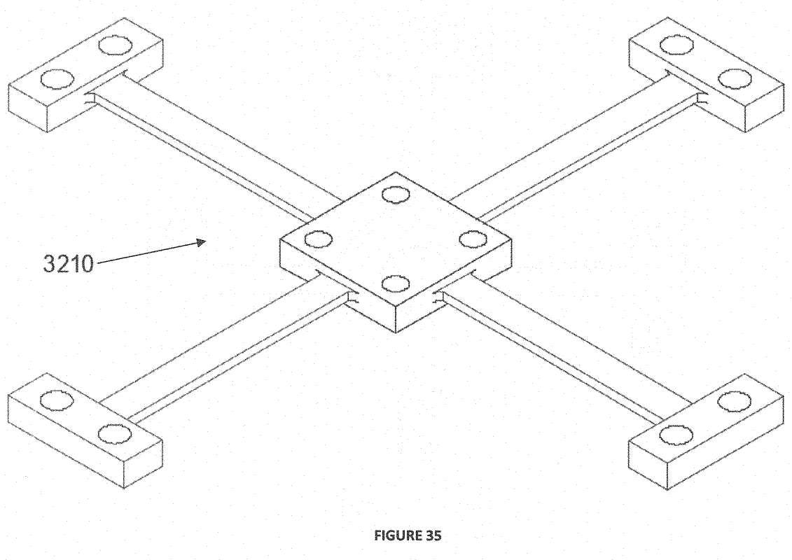

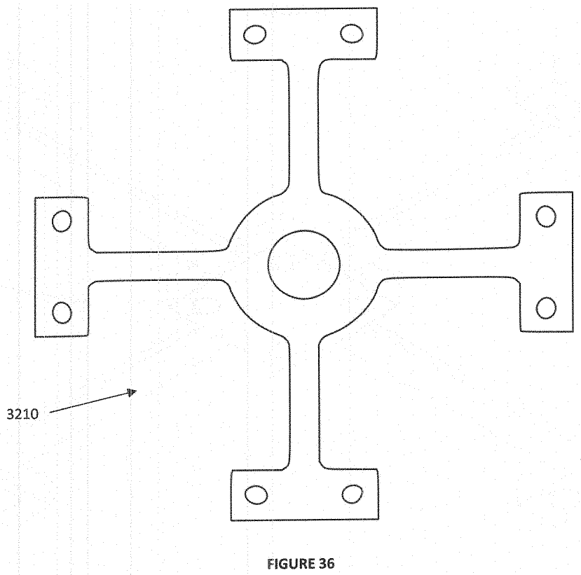

Referring now generally to the Figures and particularly to FIG. 36, FIG. 36 is a 3D model presenting a top view of the four-way string element 3210 of FIG. 35.

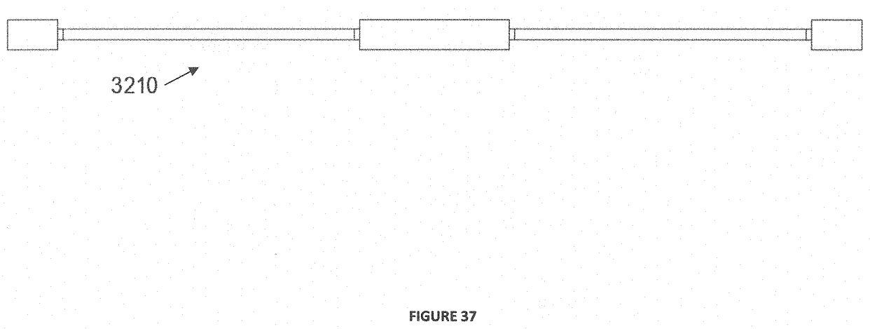

Referring now generally to the Figures and particularly to FIG. 37, FIG. 37 is a 3D model presenting a side view of the four-way string element 3210 of FIG. 35.

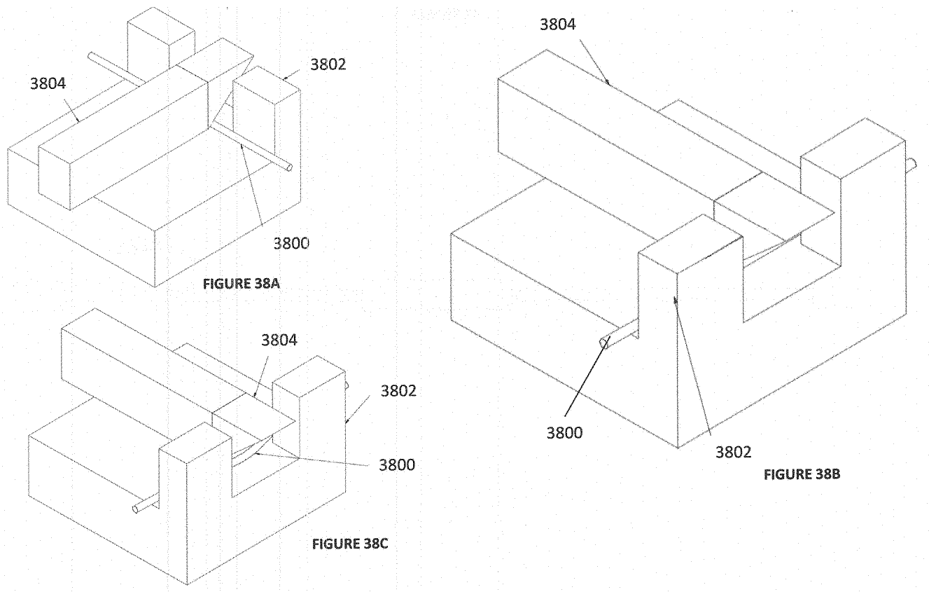

Referring now generally to the Figures and particularly to FIG. 38A, FIG. 38A is a first 3D model view of a beak feature for potential use in clamping assemblies of various embodiments such as but not limited to the invented actuator device of FIG. 1. This image presents a side view of a tendon 3800 being gripped by a U-shaped clamp piece 3802 and a beak element 3804, such that the beak element 3804 pushes the flexible tendon 3800 into the gap formed by the U-shaped clamp piece 3802, and bends the tendon 3800 around the front of the beak element 3802. This structural adaptation is considered to be a possible feature for inclusion in any embodiments of the invention as discussed herein that may improve efficiency and grip wherever clamping is required. The beak element 3804 is pushed outward toward the U-shaped clamp piece 3802, or the U-shaped-clamp piece 3802 is pulled inward toward the beak element 3804, and the tendon 3800 is forced towards the open gap between the vertical portions of the U-shaped clamp piece 3802. The movement of the beak element 3804 may bend the tendon 3800 around the shape of the beak element 3804, as shown in FIG. 38C. The tendon 3800 is pressed between the beak element 3804 and the sides of the U-shaped clamp piece 3802, so the edges of the U-shaped clamp piece 3802 and the beak element 3804 hold the string tightly and with a desirable friction. This is preferred because the U-shaped clamp piece 3802 and the beak element 3804 hold the tendon 3800 in the right position, provide significant friction when needed but have almost no friction when the beak element 3804 is displaced from that position, allowing the tendon 3800 to move smoothly when the tendon 3800 should move, but be securely and efficiently held in place when the tendon 3800 should not move. It is understood that, while a single instance of this assembly is pictured here, an H-shaped clamp piece as shown in other Figures might be preferred for providing a tandem assembly that could hold onto two tendons instead of one.

Referring now generally to the Figures and particularly to FIG. 38B, FIG. 38B is a second 3D model view of a beak feature for potential use in clamping assemblies of various embodiments such as but not limited to the invented actuator device of FIG. 1. This image presents a top view of the tendon 3800 being gripped by the U-shaped clamp piece 3802 and the beak element 3804, such that the beak element 3804 pushes the flexible tendon 3800 into the gap formed by the U-shaped clamp piece 3802, and bends the tendon 3800 around the front of the beak element 3802. This structural adaptation is considered to be a possible feature for inclusion in any embodiments of the invention as discussed herein that may improve efficiency and grip wherever clamping is required by providing additional friction. It is noted that the clamping elements 104-114 of FIG. 1A may usefully employ this beak element 3804 as a feature, and that the H-shaped outer clamping elements 108-114 of FIG. 1A may each be considered a combination of two U-shaped clamp pieces 3802 for the purposes of applying this concept.

It is noted that usage of the beak element 3804 in this capacity requires a level of displacement atypical for most PZT stacks (such as the PZT stack 102), and that this concern is addressed herein by mechanical amplification of the displacement of the PZT stack 102 through leverage. The leaned surface of the beak element 3804 can be concave or convex. The edges of the beak element 3804 might be chamfered. The beak element 3804 may be sharp or blunt, and it is noted that sharp edges of the U-shaped clamp piece 3802 into which the beak element 3804 fits may be preferred, because this may provide sharp corners for increased friction against a clamped tendon. The beak element 3804 is preferably made of metal such as hardened steel, or similar material and is preferably durable, as this element is providing friction to hold other elements in place and may be supporting weight (depending upon the application). It is noted that a non-durable beak element 3804 (such as a plastic one) might be used temporarily (such as for a demonstration of a prototype), but probably wouldn't last very long before getting bent out of shape or otherwise falling apart. It is noted, and the rest of the disclosure will show, how critical it is to the basic function of the invention overall that various clamps are able to reliably and securely grip their respective tendons without slipping or failing. The beak element 3804 feature is mentioned as a way of optimizing these critical clamping mechanisms.

Referring now generally to the Figures and particularly to FIG. 38C, FIG. 38C FIG. 38C is a third 3D model view of a beak feature for potential use in clamping assemblies of various embodiments such as but not limited to the invented actuator device of FIG. 1. This image presents a front view of the tendon 3800 being gripped by the U-shaped clamp piece 3802 and the beak element 3804, such that the beak element 3804 pushes the flexible tendon 3800 into the gap formed by the U-shaped clamp piece 3802, and bends the tendon 3800 around the front of the beak element 3802. This structural adaptation is considered to be a possible feature for inclusion in any embodiments of the invention as discussed herein that may improve efficiency and grip wherever clamping is required.

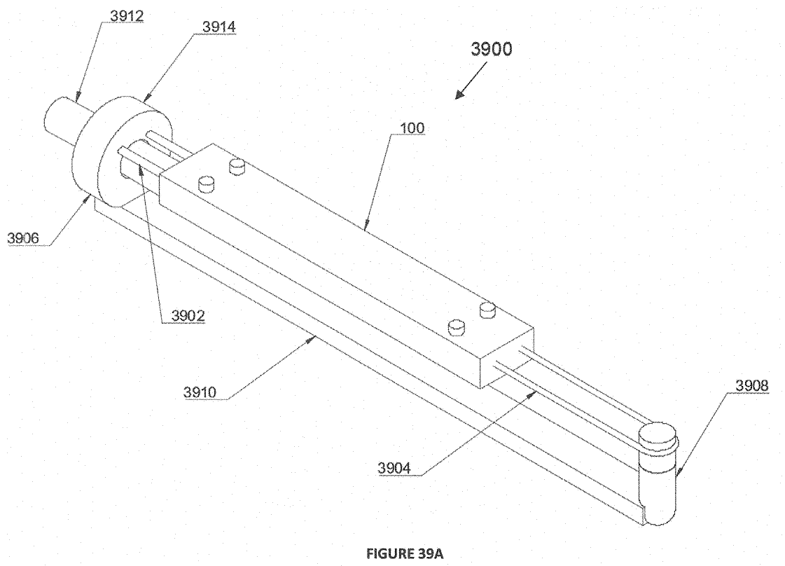

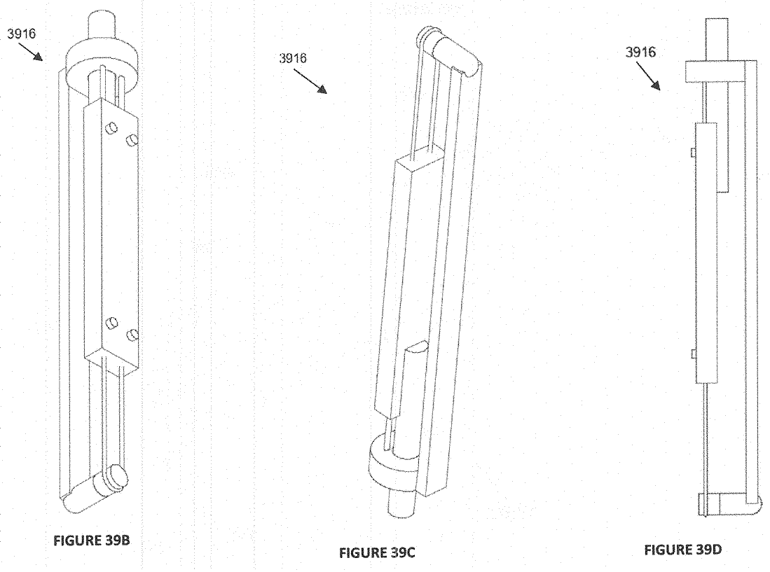

Referring now generally to the Figures and particularly to FIG. 39A, FIG. 39A is a 3D model of a bi-directional servo motor 3900 implementation utilizing an embodiment of the invented actuator device of FIG. 1A or similar embodiment of the invented device as described herein. The bi-directional servo motor 3900 may consist of the invented actuator device 100 connected to a first looped tendon 3902 and a second looped tendon 3904 (“the tendons 3902 & 3904”). It is noted that the invented actuator device 100 is pictured here as just a box, and the tendons 3902 & 3904 as simple lines, with no depiction of clamping mechanisms or other elements such as the piezoelectric stack 102. It is understood that this is a simplified representation of these elements that have already been explicated in more detail elsewhere. The invented actuator device 100, as in other implementations, may be controlled by electrical input (causing the piezoelectric stack 102 to expand, contract, and push on the clamping elements) to adjust its own position or the position or tension of the tendons 3902 & 3904. In this implementation, that functionality enables the invented actuator device 100 to shift its own position between a first end 3906 of the bi-directional servo motor 3900 and a second end 3908 of the bi-directional servo motor 3900 in response to controlled electrical input, along a base 3910 of the bi-directional servo motor 3900. The motion of the invented actuator device 100 may be further controlled by adding of a mechanical guide such as a rail. The bi-directional servo motor 3900 may further include a shaft 3912, and may also include a guide ring 3914 as shown, such that when the invented actuator device 100 shifts toward the first end 3906, the shaft 3912 is extended out beyond the first end 3906; and when the invented actuator device 100 shifts toward the second end 3908, the shaft is retracted. The guide ring 3914 may help to ensure that the extension is consistent and straight. The guide ring 3914 may be further enhanced with friction-reducing elements such as internal ball bearings and/or grease.

One potential application for the invented actuator device as explicated herein is in a bi-directional servo motor implementation, such as might be used in electronic locks and valves, or for remotely opening/closing windows, gates, or doors. While many applications of the invented actuator device are possible, including some yet unanticipated, this is an example of a possibly less-obvious way in which this new technology may be utilized. In the preferred implementation, the invented actuator device 100 is moving along and/or tightening tendons hooked onto two opposite ends of a linear frame possibly including a rail, such that the invented actuator device may move itself between one frame end and the other end, in appearance like a piston, according to control signals. For instance, the invented actuator device may be configured to move ‘up’ when the control signal is ON, and ‘down’ when the control signal is OFF, thus controlling also a lock, door, or other mechanical element connected to the actuating device. It is noted that, while one might consider the first end 3906 and the second end 3908 a practical on/off binary, the positional adjustability between these two extremes would make this mechanism operable as a fader also, rather than only a binary switch. It is noted that the shaft 3912 and guide ring 3914 need not be circular in cross-section.

Referring now generally to the Figures and particularly to FIG. 39B, FIG. 39B is a 3D model of a second bi-directional servo motor 3916 having four clamps (two clamp pairs) instead of the eight clamps of the bi-directional servo motor 3900 of FIG. 39A. It is noted that, in this case, the shaft 3912 itself provides an additional guide to keep the actuator moving in a straight line. It is possible to construct this embodiment utilizing the same elements as the bi-directional servo motor 3900. This model has the advantages of being simpler, cheaper, and more lightweight, and the disadvantage of being slower to operate. With this device only one tendon pair is moving. This means that one tendon pair could be as short as possible or even removed at all. In this case the element is mounted directly to the frame, without tendons, by lowest part of the element.

Referring now generally to the Figures and particularly to FIG. 39C, FIG. 39C is the 3D model of the bi-directional servo motor 3916 of FIG. 39B, presented from a first additional viewing angle.

Referring now generally to the Figures and particularly to FIG. 39D, FIG. 39D is the same 3D model of the bi-directional servo motor 3916 of FIG. 39B, presented from a second additional viewing angle.

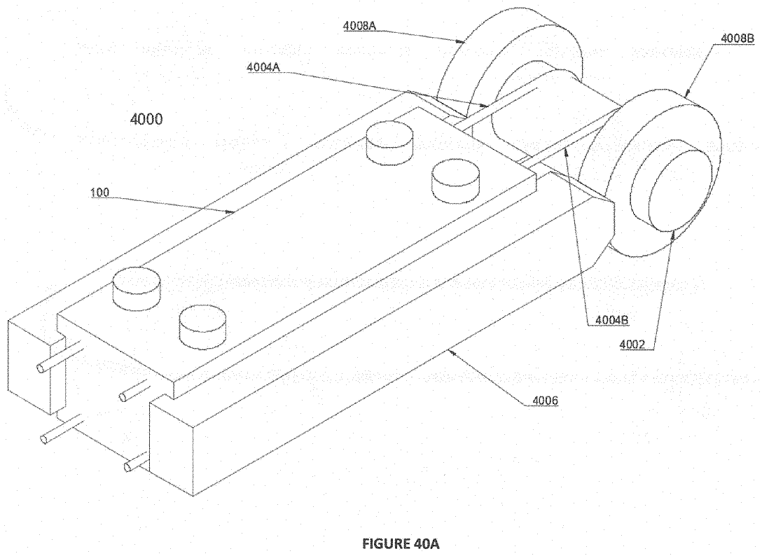

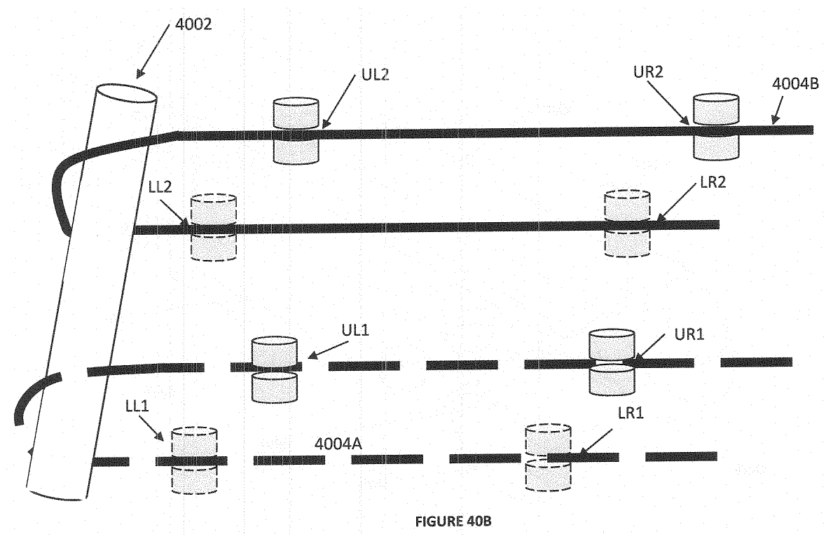

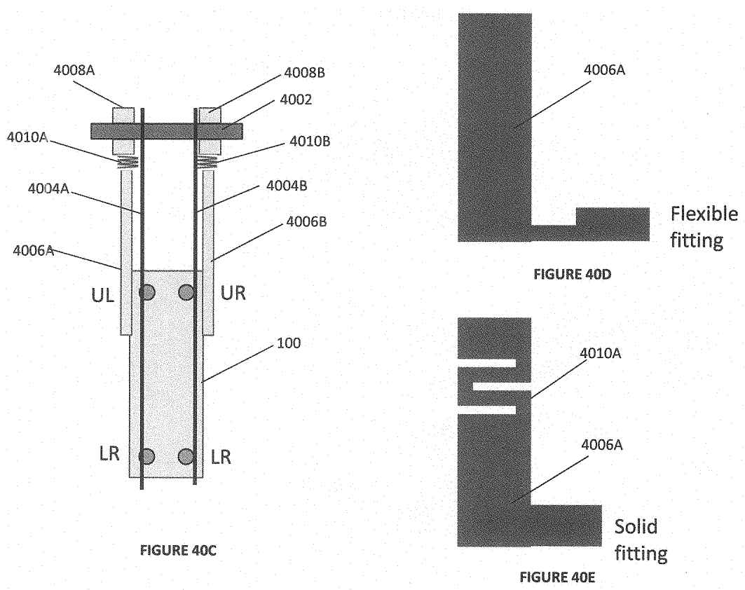

Referring now generally to the Figures and particularly to FIG. 40A, FIG. 40A is a 3D model of an axle-rotation servo motor implementation utilizing an embodiment of the invented actuator device of FIG. 1, and presents the invented actuator device 100 utilized in the context of an axle torque assembly 4000 rotatably coupled to an axle 4002. The axle torque assembly 4000 consists, in this application, of at least an instance of the invented actuator device 100, a first tendon 4004A and a second tendon 4004B (“the tendons 4004”) each looped around the axle 4002 as shown (it is noted that this is a reversal of one of the tendon orientations as presented at least in FIG. 1B, such that in this embodiment both ‘loop ends’ of tendon are facing the same direction and looped over the axle 4002), and a frame 4006 including a first bearing 4008A and a second bearing 4008B (“the bearings 4008”) securing the invented actuator device 100 rotatably in position relative to the axle 4002. It is noted that the invented actuator device 100 is pictured here as just a box, and the tendons 4004 as simple lines, with no depiction of clamping mechanisms or other elements such as the piezoelectric stack 102. It is understood that this is a simplified representation of these elements that have already been explicated in more detail elsewhere. When the tendons 4004 are pulled on by the invented actuator device 100 as disclosed elsewhere in the disclosure, friction between the tendons 4004 and the axle 4002 causes the position of the axle 4002 and axle torque assembly 4000 relative to each other to change; depending upon which elements may be fixed in place, this may either spin the axle 4002 or rotate the axle torque assembly 4000 around the axle 4002. It is noted that only the part of the axle 4002 engaging with the axle torque assembly 4000 is shown here, and this axle 4002 may be longer, such as for use in rotating a wheel or any other application for an actuated turning axle such as the axle 4002 as generally known in the art. It is also noted that only the axle torque assembly 4000 itself is shown here, while this element may also be connected to something else in need of rotation around the fulcrum point provided by the axle 4002, such as a robotic limb. Additionally, either the axle torque assembly 4000 or the axle 4002 (but probably not both, unless the intention is to saw through the axle 4002 with the tendons 4004, perhaps) may be fixed in place, such as by being bolted down to something heavy. It is noted that the bearings 4008 need not be rotatable, and having these non-rotatably coupled to the frame 4006 may be preferred. The bearings 4008 are preferably annular, or some other shape that permits rotation of the axle 4002 relative to the frame 4006. It may be useful to think of the bearings 4008 as serving the same purpose as rings on a curtain rod, if the curtain rod also had to be rotatable. In preferred operation, the invented actuator device 100 pulls on its tendons 4004, as disclosed in previous sections, thus causing friction of the tendons 4004 against the axle 4002 and causing the axle 4002 to rotate. This kind of mechanism is versatile in application, as upcoming Figures will further explicate, and is generally good for producing non-continuous motion (such as swinging an arm, and not such as continuously spinning a turbine) requiring significant torque. Another ready benefit is that this invented application is easily scalable, including, most relevantly, the ability to scale down to very small sizes. A lower limit to miniaturization is a weakness much of the prior art field of actuators shares in common, limiting the field of robotics in particular.

Referring now generally to the Figures and particularly to FIG. 40B, FIG. 40B is a diagram similar to the diagram of FIG. 1B, for presenting the differences in tendon 4004 layout and clamping position UL1-LR2 operation particular to the axle torque assembly 4000 and similar embodiments. The axle 4002 is included for positional reference. Like the device 100 as presented in FIG. 1B, the device 100 as implemented in the axle torque assembly 4000 may have eight clamping points UL1-LR2, with the tendons 4004 positioned to be gripped by these eight clamping points UL1-LR2. As a significant point of distinction, the diagram of FIG. 1B had the ‘looped’ ends of the two tendons 118 & 120 pointing in opposite directions, and oriented such that the first tendon 118 had the ‘lower’ track and the second tendon 120 the ‘upper’; in the axle torque assembly 4000 implementation, the tendon loops are pointing in the same direction, the tendons 4004 are positioned along either side of the device 100 to hang from the axle 4002 (like one's arms when hanging from an exercise bar) and the tendons 4004 are looped around the axle 4002 such that by pulling on the tendons 4004 by engaging the clamping points UL1-LR2, the device 100 can spin the axle 4002 or rotate the frame 4006 (including itself) around the axle 4002, depending on which elements may be fixed in position (e.g. bolted down). The first tendon 4004A may be threaded through the clamping points UR1, UL1, up over the axle 4002, LL1, and LR1. The second tendon 4004B may be threaded through the clamping points UR2, UL2, up over the axle 4002, LL2, and then LR2. It is noted that the designations ‘left’ and ‘right’ as established in FIG. 1B are even less accurate here, as this implementation is generally oriented with ‘left’ up and ‘right’ down, but the original clamping point designations are perpetuated for clarity in reading the diagrams.

Presented below is a table of the motions and clamping patterns of the invented actuator device 100 as connected to spinning of the axle in clockwise (CW) and counterclockwise (CCW) directions:

| | UL | LL | UR | LR | Body | | |
|---|---|---|---|---|---|---|---|
| Zero | + | + | + | + | holds the position | | |
| CCW1 | − | + | + | − | not moving | \| | |
| CCW2 | − | + | + | − | extends | \| | Repeating 4 steps |
| CCW3 | + | − | − | + | not moving | \| | continuously until |
| CCW4 | + | − | − | + | contracts | \| | reaching the position |
| Zero | + | + | + | + | holds the position | | |
| CW1 | + | − | − | + | not moving | | |
| CW2 | + | − | − | + | extends | | |
| CW3 | − | + | + | − | not moving | | |
| CW4 | − | + | + | − | contracts | | |

Referring now generally to the Figures and particularly to FIG. 40C, FIG. 40C is a diagram presenting further information regarding the mechanics of the axle torque assembly 4000 of FIG. 40A. It is noted that the tightening of the tendons is the force effecting the turning of the axle 4002, and therefore that it is preferred for as much force as possible go toward tightening the tendons, such that the axle 4002 is forced to turn in order to loosen the tension.

It is noted that this is only a diagram for explaining tendons and clamping points, and is not intended as an accurate representation of the mechanical shapes of these elements. The diagram includes the axle 4002, sections of the frame 4006 (here subdivided into a left frame leg 4006A and a right frame leg 4006B), the bearings 4008, the tendons 4004, and the device 100.

Further labeled here is an optional feature if preferred, a first spring 4010A and a second spring 4010B built into the frame 4006 as shown, providing additional flexibility or leeway for the device 100 to actuate. It is noted as an important nuance that the frame 4006 is preferred to not be entirely rigid, as the invented actuator device 100 is expanding and contracting, at least a little, in order to pull on the tendons and effect motion. Flexibility to allow for this motion of the invented actuator device 100 may preferably be built into the frame 4006, such as by including the springs 4010A & 4010B, or utilizing a flexibly fitted frame 4006 such as the frame 4006 shape of FIG. 40D. It is noted that the flexibility of the springs 4010A & 4010B in this context should generally be enough to accommodate the vertical displacement of the leg 0.02 mm-0.05 mm under the force 100-200N.

Referring now generally to the Figures and particularly to FIG. 40D, FIG. 40D is a possible shape of the frame 4006 for providing a flexible fit with the invented actuator device 100. It is understood that the invented actuator device 100 may be elongating and contracting in order to move the tendons, and this motion might be rapid to produce the intended effect on the axle 4002. In some implementations, a loose or flexible frame may be preferred for accommodating this function. It is noted that many other shapes of the frame 4006 may be possible or preferable, and this shape is offered as an example of one that may be preferred or beneficial.

Referring now generally to the Figures and particularly to FIG. 40E, FIG. 40E is a possible shape of the frame 4006 for providing a solid fit with the invented actuator device 100. It is understood that the invented actuator device 100 may be elongating and contracting in order to move the tendons, and this motion might be rapid to produce the intended effect on the axle 4002. In some implementations, a snug-fitting or solid frame may be preferred for accommodating this function, and a spring 4010A may be provided to accommodate the motion of the device 100. It is noted that many other shapes of the frame 4006 may be possible or preferable, and this shape is offered as an example of one that may be preferred or beneficial.

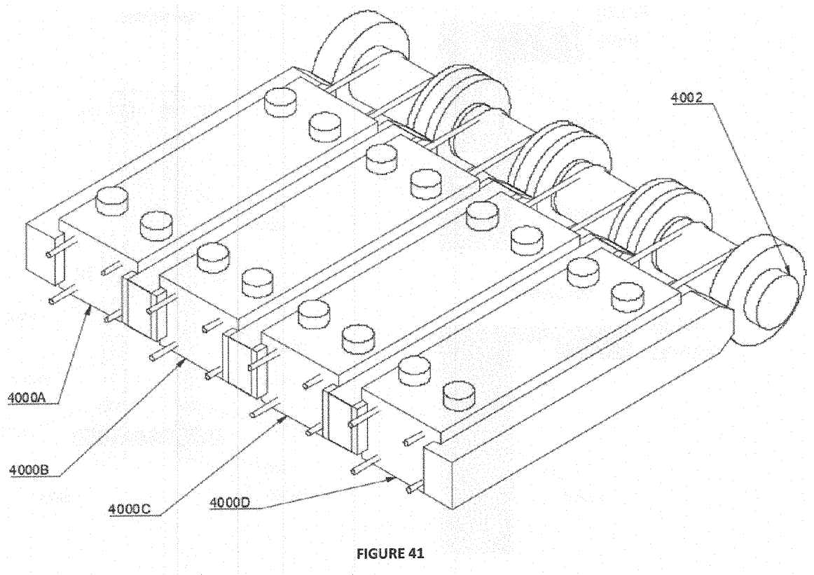

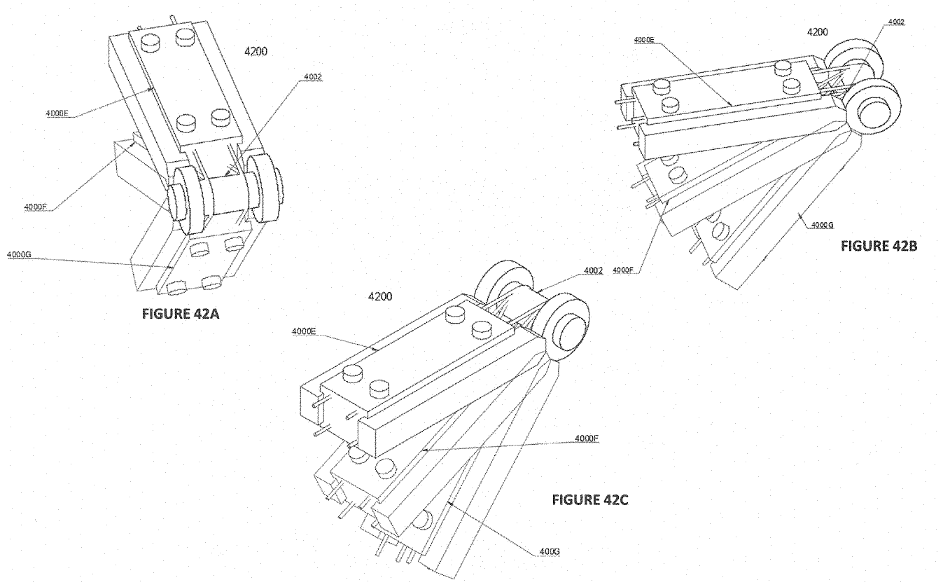

Referring now generally to the Figures and particularly to FIG. 41, FIG. 41 presents an application of four axle torque assemblies 4000, specifically a first parallel axle torque assembly 4000A, a second parallel axle torque assembly 4000B, a third parallel axle torque assembly 4000C, and a fourth parallel axle torque assembly 4000D, (collectively, “the first set of parallelized axle torque assemblies 4000A-D”) stacked in parallel along the same axle 4002, such that the force and torque provided by all four invented actuation devices 100 is applied to turning the same axle 4002. It is noted that this might be implemented by coupling of four instances of FIG. 40A together at the frames 4006, or by constructing the frame 4006 to fit four invented actuation devices 100 instead of just one. It is further noted that four is an arbitrarily-chosen number, and any quantity of these might be stacked together in similar fashion, limited only by the logistical concern of taking up increasing amounts of space in a straight line. The subject of this concern may lead into the next embodiment represented herein, starting at FIG. 42A.

Referring now generally to the Figures and particularly to FIG. 42A, FIG. 42A is a 3D model presenting three of the axle torque assemblies 4000 of FIG. 40A, specifically a fifth parallel axle torque assembly 4000E, a sixth parallel axle torque assembly 4000F, and a seventh parallel axle torque assembly 4000G, (collectively, “the second set of parallelized axle torque assemblies 4000E-G”) configured as a triad axle torque assembly 4200, for turning the same axle 4002 in concert or parallel. Rather than the linear stacking for parallelization of FIG. 41, these three axle torque assemblies 4000 form a partial arc around the axle 4002 as shown, allowing parallelization of axle torque assemblies 4000 in a format that may be more suitable and compact in many instances. It is noted that the frames 4006 and bearings 4008 of these axle torque assemblies 4000 may be partially combined as appropriate.

Referring now generally to the Figures and particularly to FIG. 42B, FIG. 42B is a second image presenting the same 3D model of FIG. 42A from a different angle. It is recognized that a directional designation such as ‘top view’ or side view' would be entirely arbitrary, and the assembly presented here might be oriented however is deemed appropriate.

Referring now generally to the Figures and particularly to FIG. 42C, FIG. 42C is a third image presenting the same 3D model of FIG. 42A from a different angle. It is recognized that a directional designation such as ‘top view’ or side view' would be entirely arbitrary, and the assembly presented here might be oriented however is deemed appropriate.

Referring now generally to the Figures and particularly to FIG. 43, FIG. 43 is a 3D model presenting twelve of the axle torque assemblies 4000 of FIG. 40A coupled in a parallelization implementation for turning the same axle 4002, continuing the idea of FIG. 42A-C into an arc that forms a full ‘star’ around the same single axle. For element numbering, the second set of parallelized axle torque assemblies 4000E-G is incorporated as ¼ of the star, in addition to an eighth parallel axle torque assembly 4000H, a ninth parallel axle torque assembly 40001, a tenth parallel axle torque assembly 4000J, an eleventh parallel axle torque assembly 4000K, a twelfth parallel axle torque assembly 4000L, a thirteenth parallel axle torque assembly 4000M, a fourteenth parallel axle torque assembly 4000N, a fifteenth parallel axle torque assembly 40000, and a sixteenth parallel axle torque assembly 4000P. This ‘star’ construction of twelve axle torque assemblies 4000 configured to rotate the same single central axle 4002 constitutes an axle torque star assembly 4300. It is noted that the axle torque star assembly 4300 is not limited to twelve axle torque assemblies 4000 may comprise any number of axle torque assemblies 4000 as the physical dimensions suit. It is further noted that an additional axle torque assembly 4000, perhaps requiring longer tendons, would fit into each triangular gap of the star shape, and the tendons belonging to that axle torque assembly 4000 could fit through the gap between the tops of two others to wrap around the axle, thus forming a possible second ‘layer’ of points of the star, which is not shown here.

Referring now generally to the Figures and particularly to FIG. 44, FIG. 44 is a 3D model presenting multiple axle torque star assemblies 4300 stacked in linear parallel along the same axle, as single axle torque assemblies 4000A-D were in FIG. 41. For element numbering, these are a first parallel axle torque star assembly 4300A, a second parallel axle torque star assembly 4300B, a third parallel axle torque star assembly 4300C, and a fourth parallel axle torque star assembly 4300D, each of these comprising a plurality of single axle torque assemblies 4000 as presented in FIG. 43. It is noted again that the number of axle torque assemblies 4000 which may fit into a construction like this may not necessarily always be twelve, and how many axle torque star assemblies 4300 may be stacked in parallel is not limited to four, which was selected arbitrarily for the purposes of demonstration here. It is further noted that this relatively compact assembly as shown provides forty-eight axle torque assemblies 4000 exerting force on the same single axle 4002, and room, as mentioned above, for forty-eight more by adding a little width and no length, or capability for expanding the length a little and providing room for another star of twelve more.

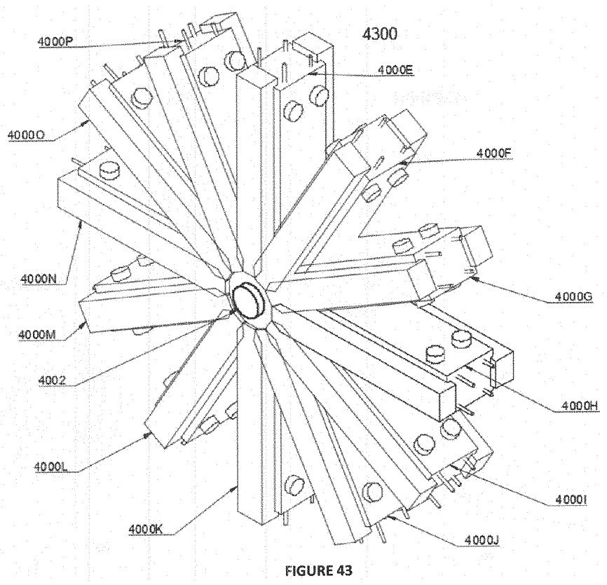

Referring now generally to the Figures and particularly to FIG. 45, FIG. 45 is a 3D model presenting an implementation of an artificial joint utilizing two of the axle torque assemblies 4000 of FIG. 40A. In this implementation, an upper axle torque assembly 4000Q and a lower axle torque assembly 4000R are oriented to pivot themselves, using their respective tendons 4004, around a joint axle 4002, such that exertion of either the upper axle torque assembly 4000Q or the lower axle torque assembly 4000R would result in the joint moving and/or bending in a comparable fashion to an elbow or knee. Again, a key benefit to this implementation is how small this mechanism could be scaled and still be functional, which is a limitation that particularly impairs robotics, as there's currently a threshold on how small, nimble, or dexterous a robot can be based on what kind of actuation technology is available to make a robot move.

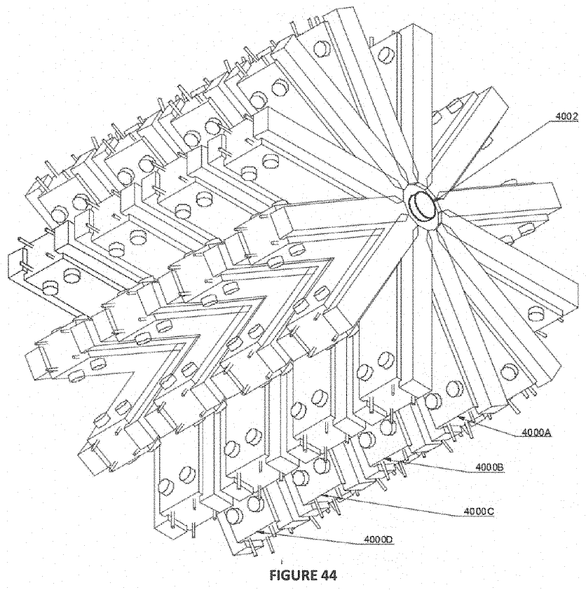

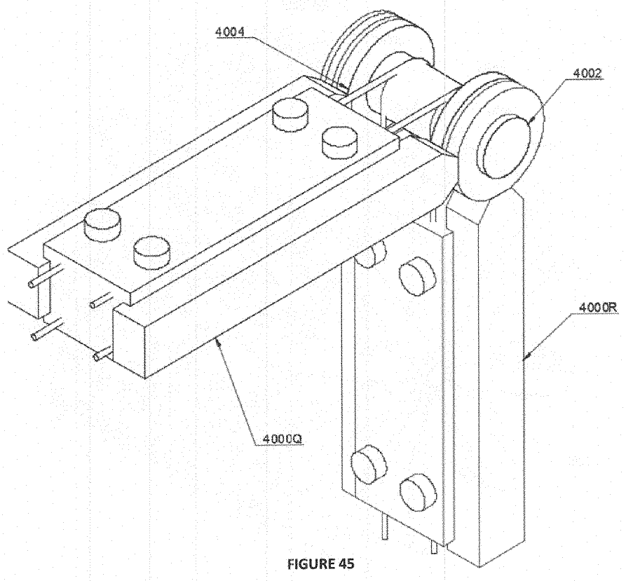

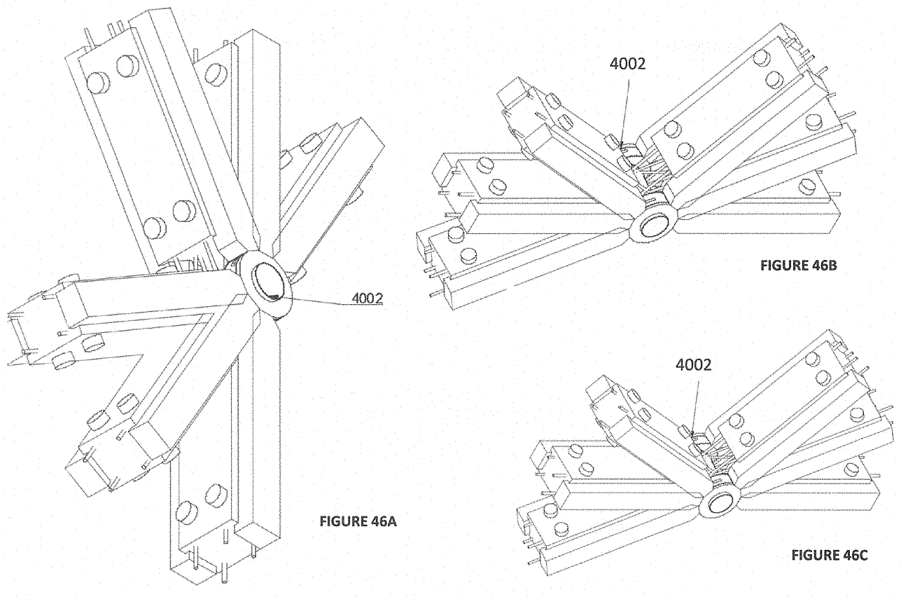

Referring now generally to the Figures and particularly to FIG. 46A, FIG. 46A is a 3D model presenting an implementation of an artificial joint similar to that of FIG. 45, but utilizing two of the triad axle torque assemblies 4200 of FIG. 42A instead of single axle torque assemblies 4000. It is noted that even with the multiple axle torque assemblies 4000 taking up more space than the single axle torque assemblies 4000 of FIG. 45, there is still a lot of room for the joint to flex.

Referring now generally to the Figures and particularly to FIG. 46B, FIG. 46B is a different angle of the 3D model of FIG. 46A. This might be considered an instance of the mechanical joint of FIG. 45 which applies the parallelization concept introduced in FIG. 42A-C.

Referring now generally to the Figures and particularly to FIG. 46C, FIG. 46C is a 3D model presenting an implementation of an artificial joint similar to that of FIG. 46A, utilizing two stacked parallelized sets of the triad axle torque assemblies 4200 of FIG. 46A, in the stacking manner of FIG. 44. This might be considered an application of the stacking concept introduced in FIG. 44 to the joint of FIG. 46A. Naturally, it is understood that the concepts introduced here are further expandable within the same patterns, such as making a similar joint but with five triads stacked, or ten, if suited to the situation at hand. This disclosure is understood to have anticipated and outlined all such obvious variations, without spelling out every possible one.

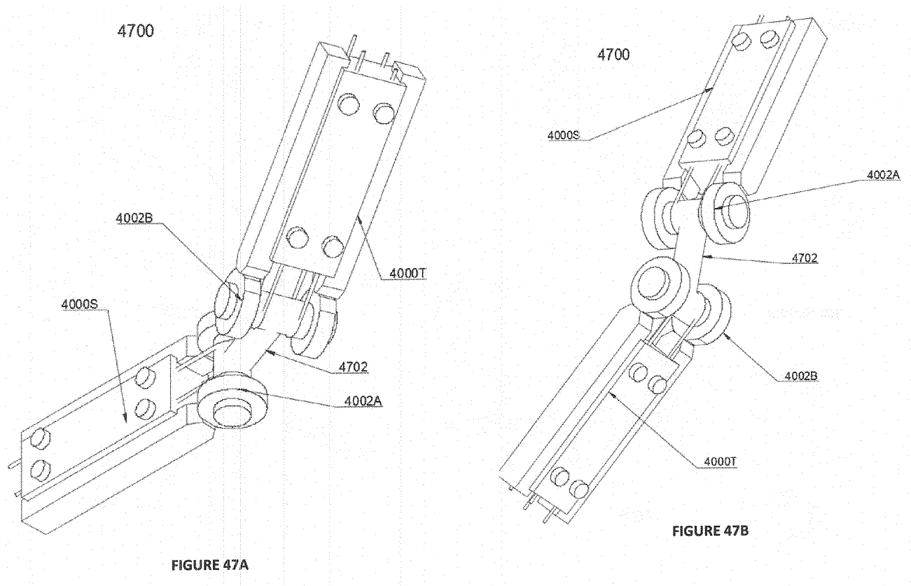

Referring now generally to the Figures and particularly to FIG. 47A, FIG. 47A is a 3D model presenting an implementation of an artificial joint having two degrees of freedom (“a 2DOF axle torque joint 4700”), utilizing two of the axle torque assemblies 4000 of FIG. 40A, specifically an upper 2DOF axle torque assembly 4000S and a lower 2DOF axle torque assembly 4000T. The upper 2DOF axle torque assembly 4000S rotates an upper axle 4002A, and the lower 2DOF axle torque assembly 4000T rotates a lower axle 4002B, and the upper axle 4002A and the lower axle 4002B are connected by a post 4702, such that rotation of either axle pulls on the other axle. This joint is capable of a broader range of motion than the single degree of freedom provided by the joint of FIG. 45.

Referring now generally to the Figures and particularly to FIG. 47B, FIG. 47B is a different angle of the 3D model of FIG. 47A. The upper 2DOF axle torque assembly 4000S rotates an upper axle 4002A, the lower 2DOF axle torque assembly 4000T rotates a lower axle 4002B, and the upper axle 4002A and the lower axle 4002B are connected by a post 4702, such that rotation of either axle pulls on the other axle. This joint is capable of a broader range of motion than the single degree of freedom provided by the joint of FIG. 45.

Referring now generally to the Figures and particularly to FIG. 47C, FIG. 47C is a closer view of the 3D model of FIG. 47B. The upper 2DOF axle torque assembly 4000S rotates an upper axle 4002A, the lower 2DOF axle torque assembly 4000T rotates a lower axle 4002B, and the upper axle 4002A and the lower axle 4002B are connected by a post 4702, such that rotation of either axle pulls on the other axle. This joint is capable of a broader range of motion than the single degree of freedom provided by the joint of FIG. 45.

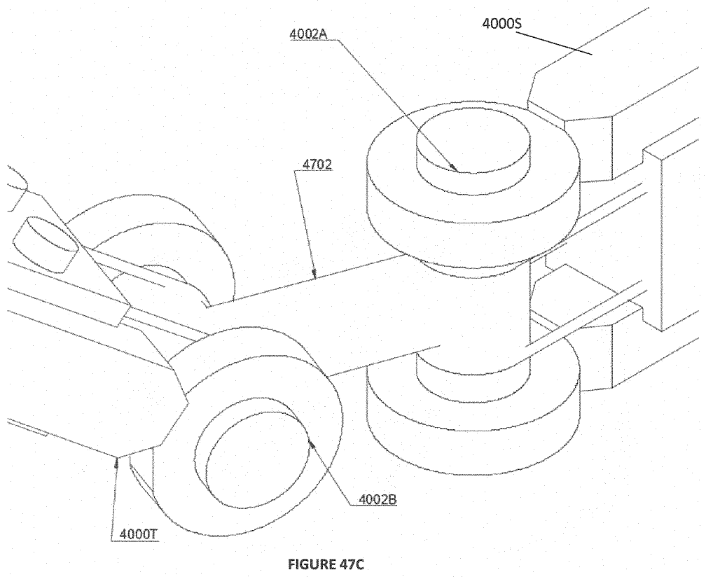

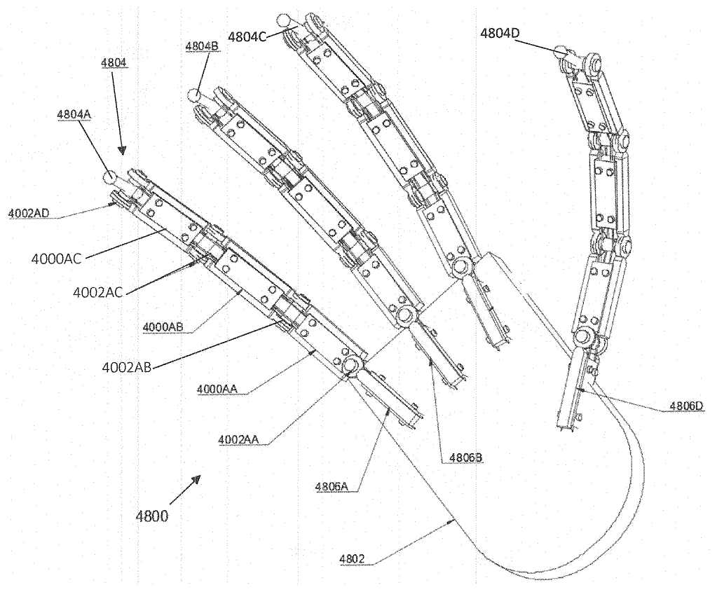

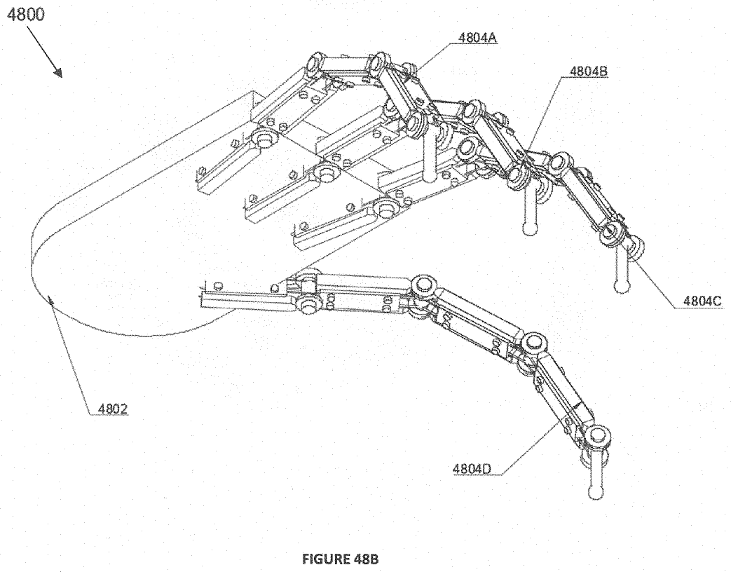

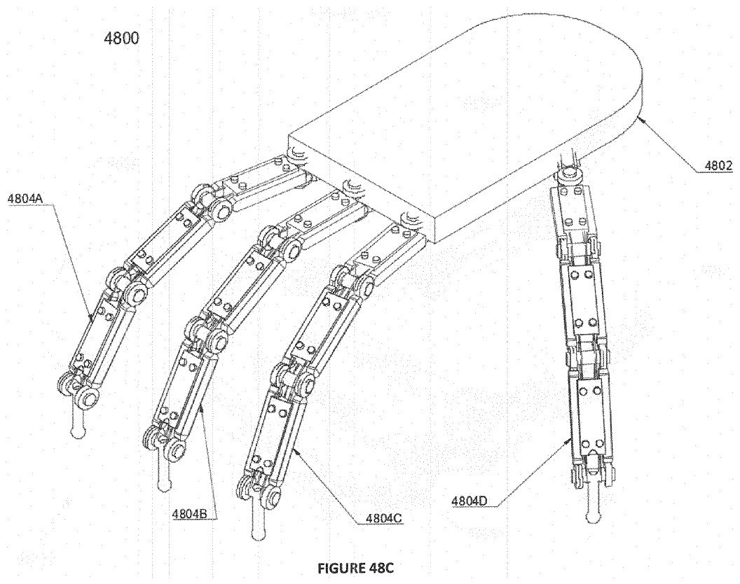

Referring now generally to the Figures and particularly to FIG. 48A, FIG. 48A is a first view of a 3D model presenting a robotic hand assembly 4800 implemented using a plurality of axle-rotation servo motor joints as presented in FIG. 46A. With particular reference to FIGS. 40A, 45, and 47A, one might already appreciate visually how these concepts have been applied to engineer a lightweight, relatively-easily-constructed handlike assembly with nimble, multi-jointed fingers. The robotic hand assembly 4800 comprises a palm 4802 coupled to at least one finger assembly 4804, specifically, a first finger assembly 4804A, a second finger assembly 4804B, a third finger assembly 4804C, and a fourth finger assembly 4804D. It is understood that the fourth finger assembly 4804D functions as a ‘thumb’ by being coupled to the palm 4802 at a different angle, and these finger assemblies 4804A-D are generally otherwise identical to each other. It is noted that, while terminology used herein to identify parts of the robotic hand assembly 4800 is inspired by the anatomical terms given to parts of the human hand, it's not necessarily a perfect metaphor and nothing should be assumed or read into this disclosure based solely on this usage of anatomical terminology. The components of the first finger assembly 4804A as described herein can be understood as also being duplicated in the other finger assemblies 4804, though only labeled on the first finger assembly 4804A and discussed in the context of the first finger assembly 4804A for this explanation. The first finger assembly 4804A further comprises at least a metacarpal actuator 4806A, a first phalange actuator 4000AA, a second phalange actuator 4000AB, a third phalange actuator 4000AC, a first knuckle axle 4002AA, a second knuckle axle 4002AB, a third knuckle axle 4002AC, a fingertip axle 4002AD, and a fingertip 4808A. It is noted that the metacarpal actuator 4806A, the first phalange actuator 4000AA, the second phalange actuator 4000AB, and the third phalange actuator 4000AC are all instances of the axle torque assembly 4000 originally introduced in FIG. 40A, and each ‘knuckle’ of the first finger assembly 4804A is an application of the artificial joint concept introduced in FIG. 45, wherein two axle torque assemblies 4000 share the same axle 4002 and pivot themselves around the axle 4002 (or pivot the axle 4002 with respect to themselves) to effect joint motion similar to that of an elbow, knee, or in this case, knuckle. It is noted that all of these axle torque assemblies 4000 include tendons (though not labeled herein) in the same manner as the assemblies of FIGS. 40A and 45, which turn the axle 4002 or pivot the position of the axle torque assembly 4000 around the axle 4002. The metacarpal actuator 4806A is coupled onto or into the palm 4802, supporting the weight of the rest of the first finger assembly 4804A and providing some lateral flexibility by controllably pivoting with the first knuckle axle 4000AA. The first phalange actuator 4000AA is coupled with the first knuckle axle 4000AA, and shares the second knuckle axle 4002AB with the second phalange actuator 4000AB as an artificial joint of FIG. 45. The second phalange actuator 4000AB further also shares the third knuckle axle 4002AC with the third phalange actuator 4000AC as an artificial joint of FIG. 45. The third phalange actuator further also pivots the fingertip axle 4002AD, to control the motion of the fingertip 4808A for gripping something. The fingertip 4808A may further be padded or adapted with a friction element such as texturing, to provide an improved gripping capability. It is again noted that, while the first finger assembly 4804A is the one described in detail, everything stated regarding the components of the first finger assembly 4804A may be understood as duplicated in the other finger assemblies 4804A-D. It is understood that this is just one possible application of this concept, and other implementations may have more or fewer fingers, fingers with more or fewer segments, differently positioned fingers, and so on, and providing of this particular example is not intended as a limitation of other possible embodiments.

Referring now generally to the Figures and particularly to FIG. 48B, FIG. 48B is a second view of the 3D model robotic hand of FIG. 47A. The robotic hand assembly 4800 comprises the palm 4802 coupled to the finger assemblies 4804, specifically, the first finger assembly 4804A, the second finger assembly 4804B, the third finger assembly 4804C, and the fourth finger assembly 4804D.

Referring now generally to the Figures and particularly to FIG. 48C, FIG. 48C is a third view of the 3D model robotic hand of FIG. 47A. The robotic hand assembly 4800 comprises the palm 4802 coupled to the finger assemblies 4804, specifically, the first finger assembly 4804A, the second finger assembly 4804B, the third finger assembly 4804C, and the fourth finger assembly 4804D.

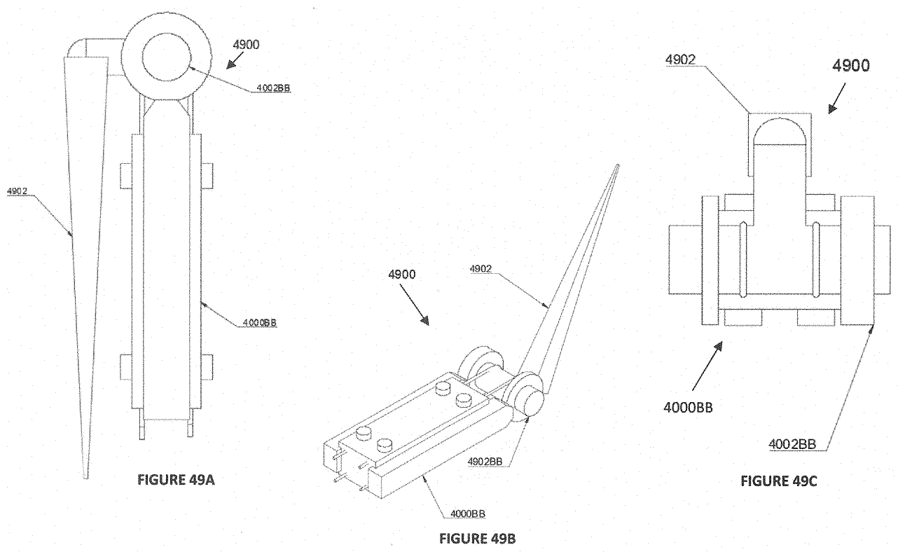

Referring now generally to the Figures and particularly to FIG. 49A, FIG. 49A is a profile view of a claw assembly 4900 implemented utilizing an axle torque assembly 4000BB of FIG. 40A. The claw assembly 4900 may comprise the axle torque assembly 4000BB, an instance of the axle torque assembly 4000 initially introduced in FIG. 40A, pivoting an axle 4002BB, and the axle 4002BB being coupled to a claw element 4902, such that when the axle 4002BB is turned or pivoted by the axle torque assembly 4000BB, the claw element 4902 folds in (as presented in FIG. 49A) or out (as presented in FIG. 49B).

Referring now generally to the Figures and particularly to FIG. 49B, FIG. 49B is a profile view of the claw assembly 4900 of FIG. 49A, with the claw 4902 folded out. The claw assembly 4900 may comprise the axle torque assembly 4000BB, an instance of the axle torque assembly 4000 initially introduced in FIG. 40A, pivoting an axle 4002BB, and the axle 4002BB being coupled to a claw element 4902, such that when the axle 4002BB is turned or pivoted by the axle torque assembly 4000BB, the claw element 4902 folds in (as presented in FIG. 49A) or out (as presented in FIG. 49B).

Referring now generally to the Figures and particularly to FIG. 49C, FIG. 49C is a top view of the claw assembly 4900 of FIG. 49A, with the claw element 4902 folded in. Referring now generally to the Figures and particularly to FIG. 49B, FIG. 49B is a profile view of the claw assembly 4900 of FIG. 49A, with the claw element 4902 folded out. The claw assembly 4900 may comprise the axle torque assembly 4000BB, an instance of the axle torque assembly 4000 initially introduced in FIG. 40A, pivoting an axle 4002BB, and the axle 4002BB being coupled to a claw element 4902, such that when the axle 4002BB is turned or pivoted by the axle torque assembly 4000BB, the claw element 4902 folds in (as presented in FIG. 49A) or out (as presented in FIG. 49B).

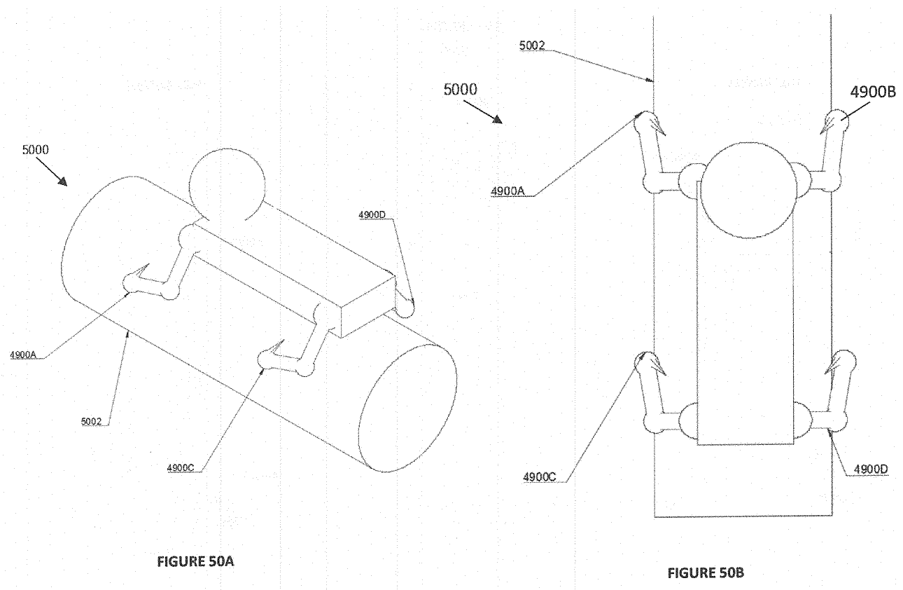

Referring now generally to the Figures and particularly to FIG. 50A, FIG. 50A is a first view of a climbing robot 5000 utilizing multiple instances of the claw assembly 4900 of FIG. 49A, specifically a first claw assembly 4900A, a second claw assembly 4900B (hidden at this angle; visible in FIG. 50B), a third claw assembly 4900C, and a fourth claw assembly 4900D, for climbing up a surface such as a pole 5002.

Referring now generally to the Figures and particularly to FIG. 50B, FIG. 50B is a second view of the climbing robot 5000 of FIG. 50A utilizing multiple instances of the claw assembly 4900 of FIG. 49A, specifically the first claw assembly 4900A, the second claw assembly 4900B, the third claw assembly 4900C, and the fourth claw assembly 4900D, for climbing up a surface such as a pole 5002.

While selected embodiments have been chosen to illustrate the invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment, it is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

I claim:

1. An apparatus comprising: a tensile element, the tensile element substantively inelastic along a traction axis, the tensile element comprising a first end and a second end; and an expandable means coupled with the tensile element by means of a coupling element wherein the tensile element is pinched by pressing of a length of the tensile element into a U-shaped gap, the expandable means adapted to expand and thereby deliver a force to the tensile element, the force initially being normal to the traction axis, whereby the force is transferred from the expandable means to the tensile element and causes the tensile element to exert force along the traction axis.

2. An apparatus comprising: a device front end, a device rear end, at least one spring element coupling the device front end extendably to the device rear end, and at least one assembly comprising:
a. a cylindrical element coupled rotatably to a selected device end selected from either the device front end or the device rear end, and coupled also to a protruding element, whereby an extension of the protruding element is increased and decreased by rotation of the cylindrical element around a central axis of the cylindrical element;
b. a first tensile element (“the first string”) substantively inelastic along a first traction axis and comprising a first string first end and a first string second end, wherein the first string first end is coupled to the cylindrical element whereby pulling on the first string rotates the cylindrical element clockwise, and the first string second end is anchored to a device end opposite the selected device end coupled to the cylindrical element;
c. a first expandable means coupled with the first string, the first expandable means adapted to expand and thereby deliver a force to the first string, the force initially being normal to the first traction axis, whereby the force is transferred from the first expandable means to the first string and causes the first string to exert force along the first traction axis and pull the cylindrical element to rotate clockwise;
d. a second tensile element (“the second string”) substantively inelastic along a second traction axis and comprising a second string first end and a second string second end, wherein the second string first end is coupled to the cylindrical element whereby pulling on the second string rotates the cylindrical element counterclockwise, and the second string second end is anchored to the device end opposite the selected device end coupled to the cylindrical element; and
e. a second expandable means coupled with the second string, the second expandable means adapted to expand and thereby deliver a force to the second string, the force initially being normal to the second traction axis, whereby the force is transferred from the second expandable means to the second string and causes the second string to exert force along the second traction axis and pull the cylindrical element to rotate counterclockwise.

3. An apparatus comprising at least one articulated joint coupling, the articulated joint coupling comprising:
a. a first side of the articulated joint coupling comprising a rigid arc with a first arc end and a second arc end;
b. a string element with a first string end coupled to the first arc end and a second string end coupled to the second arc end; and
c. a second side of the articulated joint coupling coupled to a point on the string element between the first string end and the second string end.

4. A clamping apparatus for clamping a bendable string, the clamping apparatus comprising at least:
a. a first side, the first side shaped to include a gap positioned between a first column and a second column;
b. a second side, the second side shaped to include a protruding element positioned to sit between the first column and the second column when the clamp is engaged, such that when the clamp is engaged, the bendable string is forced into the gap between the first column and the second column, and around the protruding element.

5. A bidirectional servo motor utilizing the device of claim 1, wherein

6. An axle torque servo motor utilizing the device of claim 1, wherein the force exerted by the tensile element is used to turn an axle.

7. An axle torque servo motor utilizing the device of claim 1, wherein the force exerted by the tensile element rotates the position of the device around an axle.

8. An assembly comprising a first instance of the axle torque servo motor of claim 7 (“the first axle torque servo motor”) and a second instance of the axle torque servo motor of claim 7 (“the second axle torque servo motor”) oriented around the same axle, each able to pivot its own position relative to the axle, forming a movable robotic joint.

9. An assembly comprising a first instance of the axle torque servo motor of claim 7 (“the first axle torque servo motor”) rotating itself around a first axle, and a second instance of the axle torque servo motor of claim 7 (“the second axle torque servo motor”) rotating itself around a second axle, the first axle and the second axle coupled together by a post, forming a movable robotic joint having two degrees of motion.

10. A robotic hand with fingers made of instances of the movable robotic joint of FIG. 8.

11. A robotic claw comprising the axle torque servo motor of claim 7 with a claw-shaped element coupled to the axle, such that rotating the axle unfolds or retracts the claw.

12. A climbing robot which utilizes the robotic claw of claim 11.
